(19) United States
(12) Patent Application Publication
(10) Pub. No.: US 2010/0151094 A1
(43) Pub. Date: Jun. 17, 2010

(54) METHODS, APPARATUSES, AND SYSTEMS FOR THE REMOVAL OF PEELS FROM AGRICULTURAL PRODUCE

(76) Inventors: Gour S. Choudhury, Clovis, CA (US); Bill R. Hachtmann, Oakhurst, CA (US)

Correspondence Address: MARK D MILLER;KIMBLE, MACMICHAEL & UPTON, 5260 NORTH PALM AVENUE, SUITE 221, FRESNO, CA, 93704, US

(21) Appl. No.: 12/638,896

(22) Filed: Dec. 15, 2009

Related U.S. Application Data
(60) Provisional application No. 61/122,806, filed on Dec. 16, 2008.
(60) Provisional application No. 61/243,504, filed on Sep. 17, 2009.

(51) Int. Cl. A23N 7/01; A47J 17/00

(52) U.S. Cl. 426/287; 99/516; 99/584

(57) ABSTRACT

Methods, apparatuses, and systems for removing the peels/skins from agricultural produce, such as fruits and vegetables, are disclosed. The peel and/or the connection between the peel and the flesh of the produce can be at least partially destroyed by a caustic fluid and/or steam. Once the peel has been sufficiently loosened from the flesh, forced air may be applied to the surface of the produce to remove the loosened peel and any residual caustic fluid. Using air to remove the loosened peel instead of the conventional use of water significantly reduces the freshwater requirements and substantially reduces the quantity of wastewater discharge with very low concentration of contaminants. The peels, caustic fluid, and water can be collected and separated, after which the peels can be neutralized and fed to livestock, used as fertilizer, or used for pectin production, and the caustic fluid and residual water can recycled into the system.

### RELATED APPLICATIONS

This application claims the benefit of U.S. Provisional Patent Application No. 61/122,806, filed on Dec. 16, 2008, and U.S. Provisional Patent Application No. 61/243,504, filed on Sep. 17, 2009, each of which are hereby incorporated by reference in their entirety.

### BACKGROUND OF THE INVENTION

1. Field of the Invention

The present invention generally relates to the field of food processing. More specifically, embodiments of the present invention pertain to methods, apparatuses, and systems for removing the peel of fruits, the skin of vegetables, and the outer layer of other produce or harvested crop by using caustic substances (such as lye) and/or steam, and a forced jet of air.

2. Background and Description of Related Art

Individual Quick Freezing (IQF) is a process for producing individual servings of fresh frozen fruit and vegetables. Referring now to FIG. 1, a conventional IQF process for producing a frozen peach slice begins at step 10 where fresh water may be used to wash a wholly intact peach. The wholly intact peach may be cut in half in cutting step 20 and processed to remove any pits and/or large seeds in a pitting step 30. Next, the peel may be removed in peeling step 40. After the peel has been removed, the peach halves may be sliced 50, dipped 60 in an IQF solution, frozen 70, packaged 80, and stored 90 for consumer use. In many examples, conventional IQF processes for processing peaches use fresh water in each of the washing 10, cutting 20, pitting 30, peeling 40, and slicing 50 steps. In conventional processes, the water, along with contaminants including organic and inorganic matter, is collected and may subsequently be discharged into wastewater treatment facilities.

Some conventional peeling processes may include the use of steam and/or caustic substances to remove the peel from the flesh. As shown in FIG. 2, some conventional caustic processes include four primary steps. In a first step 41, the permeability of the surface cells of the produce (for example, the peel of a fruit or the skin of a vegetable) is improved. In a second step 43, a caustic substance (such as an aqueous lye solution) is applied to the produce to begin destroying the connection between the peel and the edible flesh of the produce. After the lye has been applied, it may be allowed to react for some time in a reaction step 45 until the connection between the peel and the flesh has been sufficiently destroyed, disintegrated, or otherwise impaired. In a final removal step 47, the peel may be removed. Removal step 47 conventionally includes rinsing the produce with substantial amounts of water.

Referring to the illustration of FIG. 3, the peel of a peach is attached to the edible flesh by layers of cells. The fibrillar cellulose in the walls of the individual cells is connected by a matrix of hemicelluloses and pectic substances. The hemicelluloses bind with the pectic substances between the fibrillar cellulose. Because hemicelluloses are easily hydrolyzed by a dilute base, and because pectic substances can be dissolved by the application of heat, the matrix can be broken down by the application of a heated, aqueous lye solution. Once the matrix is destroyed, the peel can be easily removed. In other examples, and referring to the illustration of FIG. 4, the skin or epidermis of a tomato is attached to portions of the vascular bundle. Lye may be used to destroy the connection between the skin and the vascular bundle so that the skin may be easily removed.

A conventional system of using lye to remove the peel of some produce (and in the following example, using lye to remove the peel of a peach) is shown in the example of FIG. 5. An unpeeled peach may be conditioned in conditioning step 141 to improve the permeability of the peel. In some examples, the peach may be subjected to warm fluid and/or hot or cold air to ensure that the peel is at an optimal temperature and moisture level, and that the flesh is at an optimal temperature, for subsequent steps.

After conditioning 141, the peach may be subjected to hot lye in an application step 143 to begin the process of destroying the cell walls of the peel itself, or cells which are located immediately below the peel. Although any type of lye may be used, typically, in peach and some other fruit applications, the lye is an aqueous solution of about 1% and about 4% Sodium Hydroxide (NaOH) or Potassium Hydroxide (KOH). Typically, the temperature of the lye is between about 65° C. and about 90° C. and is applied to the peel of the peach for between about 5 and about 60 seconds.

The lye may then be allowed to react with the peel in a reaction step 145 to loosen the peel from the flesh. Typically, this step involves subjecting the peach to steam for between about 5 and about 60 seconds. The steam is typically saturated and applied at atmospheric pressure. However, in some examples, pressurized steam may be applied at between about 90° C. and about 200° C. Various time, temperature, pressure, and lye concentrations may be used depending on the variety of peach and the quality of the flesh and the peel.

Conventionally, the peel of a peach (or the skin of a tomato) is separated from the flesh by drenching the produce with a large amount of water at high pressure in a separation step 147. This step may be followed by a final water rinse 149. In one example, the peel separation step 147 may involve cold water sprayed at high pressure towards the fruit, causing the peel to fall off. In addition to causing the peel to fall off, the use of water in the separation 147 and rinse 149 stages serve a second purpose: to remove any residual lye which may be present on the produce. Lye is a caustic base so it must be sufficiently removed from the fruit before being consumed. In some conventional lye-based peach peeling systems, separation step 147 and rinse step 149 require water at a rate of approximately 44 gallons per minute (GPM) to process three short tons of peeled peach product.

Conventional systems for removing the skin from tomatoes are shown in the examples of FIGS. 6A and 6B. The connection between the skin and the vascular bundle of the tomato may be destroyed by caustic processes or steaming processes. Referring to FIG. 6A, caustic-based peeling processes can include a soaking step 243 where a tomato is placed in a vat or other similar container of a caustic fluid, such as lye. Similar to the peach peeling process described above, reaction step 245 can include placing the tomato in a steam chamber to allow the lye to react with the skin/flesh connection. The skin may thereafter be removed in a separation step 247 wherein a large amount of water is sprayed towards the tomato, causing the loosened skin to peel away from the flesh.

In other conventional tomato peeling systems, the connection between the skin and the vascular bundle can be destroyed by steaming the fruit. As illustrated in the example of FIG. 6A, the tomato may first be conditioned in a conditioning step 341. Thereafter, the tomato can be exposed to steam in a destruction step 345 to destroy the skin/vascular bundle connection. In some conventional systems, a separation step 347 can include the use of scrubbers, cords, chains, etc. to mechanically separate the loosened skin from the flesh of the tomato.

With respect to conventionally caustic peeling systems, it is important to note that while the wastewater generated from the lye application and reaction steps presents an environmental concern, their contribution, in terms of total discharge quantity, is not as significant in comparison to the wastewater generated by the removal and rinse steps. As above, some conventional lye-based peach peeling systems can consume water at a rate of 44 gallons per minute to remove the loosened peel from the flesh. As a result, food processing plants using such conventional systems are faced with the challenge of neutralizing or otherwise reducing the environmental impact of wastewater having a pH of greater than 11.8 at a rate of over 44 gallons per minute. Moreover, it is not just the quantity, but also the quality, of wastewater discharge which is an environmental concern. The byproducts of conventional processes have comparatively large chemical oxygen demand (COD), total suspended solids (TSS), total dissolved solid (TDS), and high salinity. These factors significantly affect the ability of wastewater treatment facilities to effectively process the discharge.

Processing the liquid byproducts (i.e., wastewater) of conventional peeling methods is of major concern to the agricultural industry. Typical conventional processes involve either discharging the wastewater on the earth's surface to allow it to dry or expensive treatment by wastewater treatment facilities. In addition, discharge of wastewater containing high organic and inorganic loads is a major concern to the fruit and vegetable processing industry because of increased regulatory requirements. Treatment of wastewater is becoming increasingly cost prohibitive as wastewater treatment plants in some areas are reaching their maximum capacity. It is therefore desirable to provide methods, apparatuses, and systems for removing the peel, skin, and/or other outer layer of agricultural produce whereby the quantity of water consumption and wastewater discharge is reduced, and the quality of wastewater discharge is improved.

### SUMMARY OF THE INVENTION

Embodiments of the present invention relate to methods, apparatuses, and systems for removing surface cells of agricultural produce by forced air. More specifically, after the connection between the surface cells and the flesh of the produce has been disintegrated, air is forced upon the produce causing the surface cells to be separated from the flesh of the produce.

In some aspects, the invention concerns a method for separating an outer peel portion from an inner flesh portion of a piece of agricultural produce, which may include the steps of: at least partially destroying a connection between the peel and the flesh using thermal processes and/or chemical processes; and thereafter, exposing a surface of the peel to a jet of air having sufficient kinetic energy to substantially separate the peel from the flesh of the produce.

In some embodiments, the step of at least partially destroying the connection may include applying a heated caustic fluid to the surface of the peel. In some embodiments, the step of applying the caustic fluid to the surface of the peel may include spraying the caustic fluid on the surface of the peel. In some embodiments, the method may further include the step of waiting a first period of time to allow the caustic fluid to react with the connection. In some embodiments, the method may further include the step of exposing the produce to steam during the first period of time.

In some embodiments, the step of applying the caustic fluid to the surface of the peel may include depositing the piece of produce in a container filled with a heated caustic fluid.

In some embodiments, the step of at least partially destroying the connection comprises the step of exposing the produce to steam.

In some embodiments, the step of exposing the surface of the peel to the jet of air may include the step of moving the produce along a conveyor underneath the jet of air.

In some embodiments, the jet of air may be formed by causing air from a blower, a compressor, and/or a tank of compressed gas to exit from a nozzle of at least one stationary peeler. In some embodiments, the jet of air may be formed by causing air from a blower, a compressor, and/or a tank of compressed gas to exit a nozzle of at least one rotating peeler. In some embodiments, the rotating peeler may include at least two nozzles rotatable about a first axis, where motion of the peeler is imparted by angling exhaust vents of each of the nozzles relative to the first axis.

In some embodiments, the method may further include the step of applying a small amount of moisture to the surface of the peel. In some embodiments, the moisture may be applied to the surface of the peel by injecting a fluid into the jet of air. In some embodiments, the moisture may be applied to the surface of the peel by spraying a fluid onto the surface of the peel immediately prior to exposing the surface of the peel to the jet of air. In some embodiments, the amount of moisture may be less than about one gallon per minute per short ton of produce.

In some aspects, the invention concerns a method which may include: a conditioning step comprising exposing an agricultural produce to steam and/or water to improve the permeability of a peel of the produce; an application step comprising applying a lye solution to a surface of the peel, the lye comprising sodium hydroxide and/or potassium hydroxide; a reaction step comprising exposing the produce to steam and/or heat to cause the lye to loosen the peel from a flesh of the produce; a peel separation step comprising impacting a surface of the peel with a jet of air having sufficient kinetic energy to substantially separate the loosened peel from the flesh; and a rinsing step comprising rinsing the produce with water to remove residual peel and residual lye from the produce.

In some embodiments, the method may further include the step of recycling fluid from the conditioning step, the application step, the reaction step, the peel separation step, and/or the rinsing step.

In some aspects, the invention concerns a system which may include: a conveyor for transporting an agricultural produce, the produce comprising an outer peel portion connected to an inner flesh portion; a destroying means, comprising caustic fluid and/or steam for at least partially destroying a connection between the peel and the flesh of the produce; and at least one peeler directing a jet of air towards a surface of the peel of the produce, the air having sufficient kinetic energy to substantially separate the peel from the flesh of the produce.

In some embodiments, the peeler may include (i) an intake port in fluid communication with an air supply and (ii) at least one nozzle in fluid communication with the intake port. In some embodiments, the air supply may include a compressor, a blower, and/or a container of compressed gas. In some embodiments, the compressed gas may be hydrogen, nitrogen, carbon dioxide, sulfur dioxide, and/or ozone.

In some embodiments, the intake port of the peeler may further be in fluid communication with a fluid supply for injecting a fluid into the jet of air. In some embodiments, the fluid supply may include an atomizer, a steam generator, a humidifier, and/or a water pump. In some embodiments, the fluid may be water, sucrose, an acid, ascorbic acid, citric acid, and/or a neutralizing agent.

In some embodiments, the system may further include a vertical drum, where the conveyor operates helically within the drum, and where the at least one peeler is disposed above a portion of the conveyor. In some embodiments, the system may further include a horizontal drum and a rotating screw for transporting the produce within the drum, where the at least one peeler is disposed between an axis of the screw and a bottom inside portion of the drum. In some embodiments, a plurality of flexible cords may extend along the bottom portion of the drum for applying friction to the produce.

In some embodiments, the system may further include at least one applicator for applying water, sucrose, an acid, ascorbic acid, citric acid, and/or a neutralizing agent to the peel.

In some embodiments, the system may further include an ozone generator, an ionizer, and/or an ultraviolet light source.

In some embodiments, the destroying means may further include at least one applicator for applying the caustic fluid to the surface of the peel. In some embodiments, the destroying means may further include a tank of the caustic fluid for temporarily receiving the produce. In some embodiments, the destroying means may further include a chamber filled with the steam. In some embodiments, the destroying means may further include rollers, chains, brushes, cables, cords, and/or knives for applying mechanical force to the surface of the peel.

In some embodiments, each of the at least one peeler may include at least two nozzles, the nozzles each rotating about a first axis. In some embodiments, the nozzles may rotate at between about 30 and 3000 revolutions per minute.

In some embodiments, the system may further include a plurality of peelers. In some embodiments, at least two of the plurality of peelers may be configured in series. In some embodiments, at least two of the plurality of peelers may be configured in parallel. In some embodiments, at least two of the plurality of peelers may be staggered from each other.

In some aspects, the invention concerns a peeler for separating a peel from a flesh of an agricultural produce which may include: an intake port in fluid communication with a blower, a compressor, and/or a tank of compressed gas; and at least one nozzle in fluid communication with the intake port for directing a jet of air towards a surface of the peel of the produce after the peel is loosened from the flesh by a caustic fluid applicator, a container of caustic fluid, a steam applicator, and/or a steam chamber. In some embodiments, the jet of air may have sufficient kinetic energy to substantially separate the peel from the flesh of the produce.

In some embodiments, the peeler may include a swivel assembly between the intake port and the at least one nozzle for enabling rotational movement of the peeler. In some embodiments, the peeler may rotate about a first axis at between about 30 and about 3000 revolutions per minute. In some embodiments, each nozzle may include an exhaust vent at a distal end thereof. In some embodiments, the exhaust vent may provide the air at a rate of between about 5 and about 50 cubic feet per minute. In some embodiments, the exhaust vent may provide the air at a pressure of between about 30 and about 150 pounds per square inch. In some embodiments, the exhaust vent may be between about 2 and about 4 inches from the surface of the peel. In some embodiments, the exhaust vent may have a width between about 2 and about 10 times less than a diameter of the produce.

In some embodiments, the peeler may comprise a manifold between the swivel assembly and the at least one nozzle. In some embodiments, the peeler may include at least two nozzles and at least two arms, where each of the arms is engaged with (i) the manifold on a proximal end and (ii) one of the nozzles on a distal end. In some embodiments, each of the arms may have a length of between about 2 and about 5 times a diameter of the produce.

In some embodiments, each nozzle may have an exhaust vent with a geometry corresponding to a geometry of the produce. In some embodiments, the exhaust vent may have a geometry defined by an arc having an angle of between about 60 and about 180 degrees, where the focal point of the arc is about at the same position as the geometrical center of the produce. In some embodiments, the peeler may include at least two nozzles, where each of the nozzles are in fluid communication with each other.

In some embodiments, the peeler may further include a fluid applicator in fluid communication with a mister, an atomizer, a steam generator, and/or a humidifier for applying a fluid onto the surface of the peel. In some embodiments, the intake port may further be in fluid communication with an atomizer, a steam generator, and/or a humidifier for injecting a fluid into the jet of air.

In some aspects, the invention concerns a system for removing an outer peel portion of an agricultural product which has been loosened from an inner flesh portion of the produce by caustic and/or steaming means, the system may include: a plurality of peelers, each peeler directing a jet of air towards a surface of the peel, the air having sufficient kinetic energy to substantially separate the peel from the flesh of the produce; a plurality of fluid applicators, each applicator applying a fluid to the surface of the peel of the produce; and a recycling system collecting discharge from the plurality of peelers and/or the plurality of fluid applicators, wherein the recycling system separates the discharge into a solid byproduct and a liquid byproduct.

In some embodiments, at least two peelers may be configured in series. In some embodiments, at least one fluid applicator may be located between the at least two series peelers. In some embodiments, at least two peelers may be configured in parallel. In some embodiments, at least two peelers may be staggered from each other.

In some embodiments, each of the peelers may include a swivel assembly and at least two arms extending from a manifold engaged with the swivel assembly, where each of the arms have a nozzle on an end thereof. In some embodiments, the peelers may rotate at between about 30 and about 3000 revolutions per minute.

In some embodiments, the recycler may include a neutralizing agent for neutralizing the solid byproduct. In some embodiments, at least one of the fluid applicators may receive the liquid byproduct from the recycler.

In some embodiments, at least one of the fluid applicators may be a mister, an atomizer, a steam generator, and/or a humidifier. In some embodiments, the peeler may further include an atomizer, a steam generator, and/or a humidifier for injecting a fluid into the jet of air.

In some aspects, the invention concerns a system having caustic and/or steaming means for loosening a peel from the flesh of a produce, an improvement may include at least one peeler directing a jet of air towards a surface of the peel, the air having sufficient kinetic energy to substantially separate the peel from the flesh of the produce. In some embodiments, the system may further include a mister, an atomizer, a steam generator, and/or a humidifier for applying a fluid on the surface of the peel of the produce.

In some aspects, the invention concerns a method for removing peels from harvested agricultural crops which may include the steps of: exposing the crops to steam and/or water to improve the permeability of the peels; applying a first solution to surfaces of the peels, the first solution comprising lye; exposing the surfaces of the peels to steam and/or heat to cause the solution to loosen the peels from inner flesh portions of the crops; directing at least one jet of air toward the surfaces of the peels, wherein the jet of air has sufficient kinetic energy to substantially separate the peels from the flesh portions; and rinsing the crops with water to remove any of the first solution remaining on the crops.

In some embodiments, the method may further include the steps of collecting the separated peels and neutralizing the separated peels with a neutralizing agent. In some embodiments, the method may further include the step of collecting the water used to remove the remaining first solution. In some embodiments, the method may further include the steps of adding concentrated lye to the collected water and recycling the collected water and the concentrated lye into the first solution. In some embodiments, the method may further include the steps of recycling the collected water and using it to remove any of the first solution remaining on additional crop.

As above, embodiments of the present invention concern apparatus, systems, and methods which reduce freshwater demand and external processing requirements. By using air as the primary means for removing the peel and residual caustic fluid, if any, in contrast to the conventional use of water, more environmentally friendly systems can be achieved. In some examples, and without limitation, removing the peel from peaches in accordance with some embodiments of the present invention may have a total freshwater demand of only between about 1 and about 3 GPM, in contrast to conventional systems which require greater than approximately 44 GPM of water to process three short tons of peeled peaches. By significantly reducing the amount of water used in the peeling process (by replacing it with forced air or forced air and/or a small amount of fluid), nearly all of the caustic fluid and water may be recycled and reused. Furthermore, the removed peels may be neutralized and used as animal feed or processed into other products, such as, for example, fertilizer or pectin.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a diagram showing a conventional method for producing IQF fruit slices.

FIG. 2 is a diagram showing a conventional lye peeling method.

FIG. 3 is a diagrammatical representation of the cell wall of a peach.

FIG. 4 is a diagrammatical representation of a cross-section of a tomato.

FIG. 5 is a diagram showing a conventional lye-based peach peeling method.

FIG. 6A is diagram showing a conventional lye-based tomato peeling method.

FIG. 6B is diagram showing a conventional steam-based tomato peeling method.

FIG. 7 is a diagram showing an exemplary caustic peeling method in accordance with some embodiments of the present invention.

FIG. 8A is a diagram showing another exemplary caustic peeling method in accordance with some embodiments of the present invention.

FIG. 8B is a diagram showing an exemplary steam peeling method in accordance with some embodiments of the present invention.

FIG. 9 is a diagram showing an exemplary peeling process in accordance with some embodiments of the present invention.

FIG. 10 is a diagram showing an exemplary horizontal caustic peeling system in accordance with some embodiments of the present invention.

FIG. 11 is a diagram showing another exemplary horizontal caustic peeling system in accordance with some embodiments of the present invention.

FIG. 12 is a diagram showing an exemplary vertical peeling system in accordance with some embodiments of the present invention.

FIG. 13 is a diagram showing an exemplary drum peeling system in accordance with some embodiments of the present invention.

FIG. 14 is a perspective view of an exemplary rotating peeler in accordance with some embodiments of the present invention.

FIG. 15 is a side view of the exemplary peeler of FIG. 14.

FIG. 16 is a profile view of the exemplary peeler of FIG. 14.

FIG. 17 is a perspective view of another exemplary rotating peeler in accordance with some embodiments of the present invention.

FIG. 18 is a perspective view of a plurality of rotating peelers in accordance with some embodiments of the present invention.

FIG. 19 is a top view of a peeling system in accordance with some embodiments of the present invention.

FIG. 20 is a perspective view of an exemplary contoured peeler in accordance with some embodiments of the present invention.

FIG. 21 is a perspective view of a plurality of contoured peelers in accordance with some embodiments of the present invention.

FIG. 22 is a perspective view of another exemplary contoured peeler in accordance with some embodiments of the present invention.

FIG. 23 is a perspective view of an exemplary flat peeler in accordance with some embodiments of the present invention.

FIG. 24 is a side view of an exemplary rinsing system in accordance with some embodiments of the present invention.

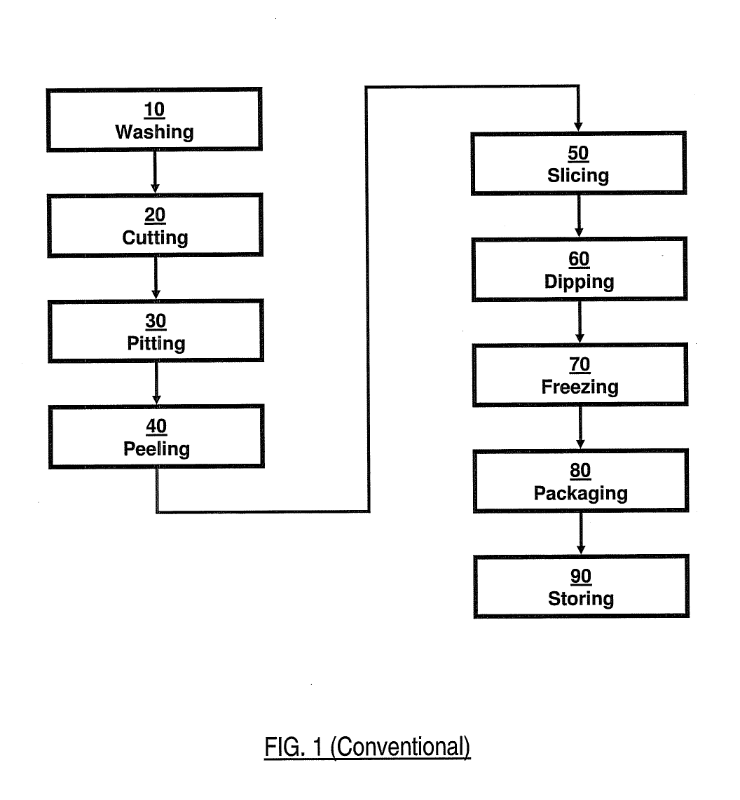

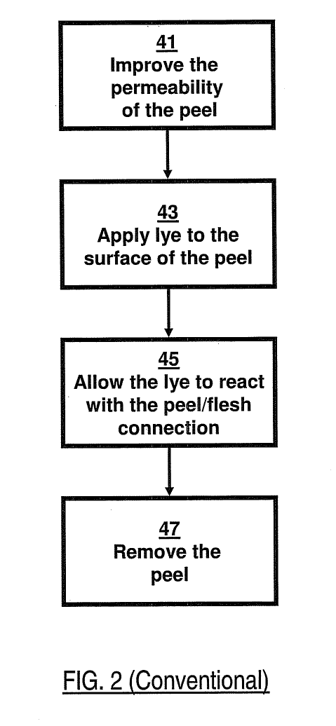

### DETAILED DESCRIPTION OF THE PREFERRED EMBODIMENTS

The invention, in its various aspects, will be explained in greater detail below. While the invention will be described in conjunction with several exemplary embodiments, the exemplary embodiments themselves do not limit the scope of the invention. Similarly, the exemplary embodiments as illustrated in the accompanying drawings do not limit the scope of the exemplary embodiments and/or invention. Rather the invention, as defined by the claims, may cover alternatives, modifications, and/or equivalents of the exemplary embodiments.

It is to be appreciated that although the invention is described in conjunction with reference to methods, apparatuses, and systems for removing the peels from peaches and/or skins from tomatoes, it is to be appreciated that embodiments of the invention also contemplate removing the outer surface of any agricultural product or harvested crop having a permeable or semi-permeable outer layer and a fleshy inner layer. For example, embodiments of the present invention also contemplate apparatuses, systems, and methods for removing the surface cells (for example, and without limitation, the peel and/or skin) of persimmons, nectarines, plums, apricots, apples, and various vegetables. It is further to be appreciated that the terms “skin”, “peel”, and “surface cells”, “outer layer” may be used interchangeably, and generally refer to the outer protective surface of a fruit, vegetable, or other produce, such as the exocarp, whether cellular, vascular, waxy, fibrous, or otherwise, while the term “flesh” generally refers to an inner edible material of the fruit, vegetable, or other produce.

It is also to be appreciated that although the invention is described in conjunction with reference to produce having a peel loosened from its flesh by caustic processes or steaming processes, it is to be appreciated that embodiments of the invention also contemplate to other processes for loosening the peel from the flesh. In addition, although the invention may be described in conjunction with reference to lye, sodium hydroxide, or potassium hydroxide, it is to be appreciated that other caustic substances are contemplated in accordance with some embodiments of the present invention.

Exemplary Methods for Peeling Produce

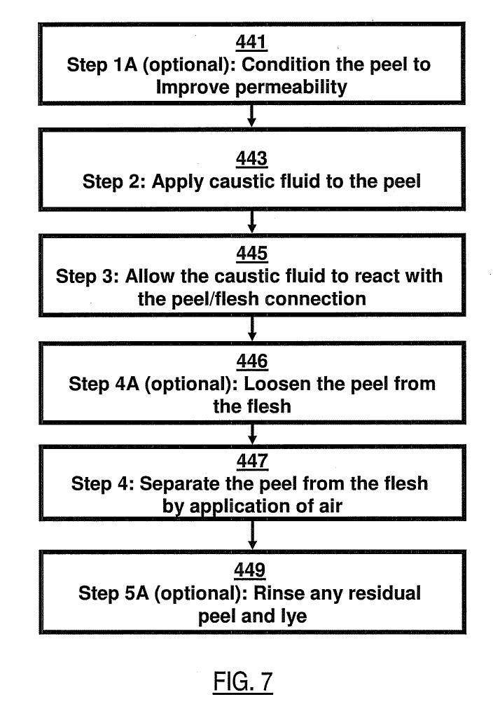

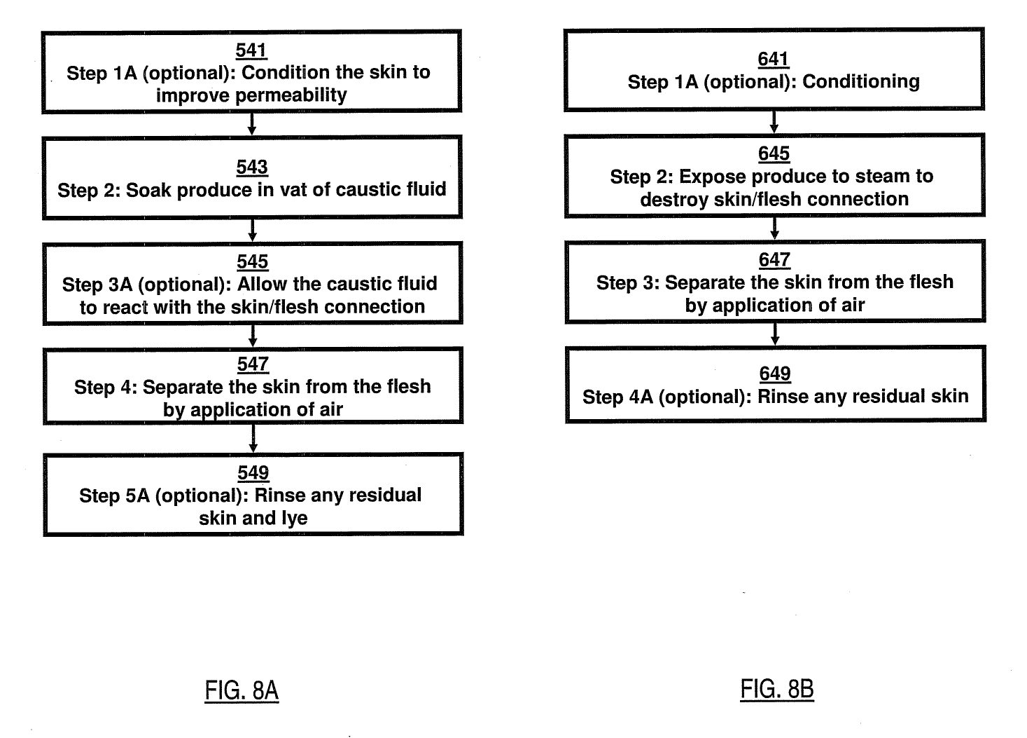

Referring now to the exemplary illustrations of FIGS. 7 and 8A-8B, in preferred embodiments, methods can include the advantageous step of separating the loosened peel or skin of an agricultural produce by application of a forced jet of air.

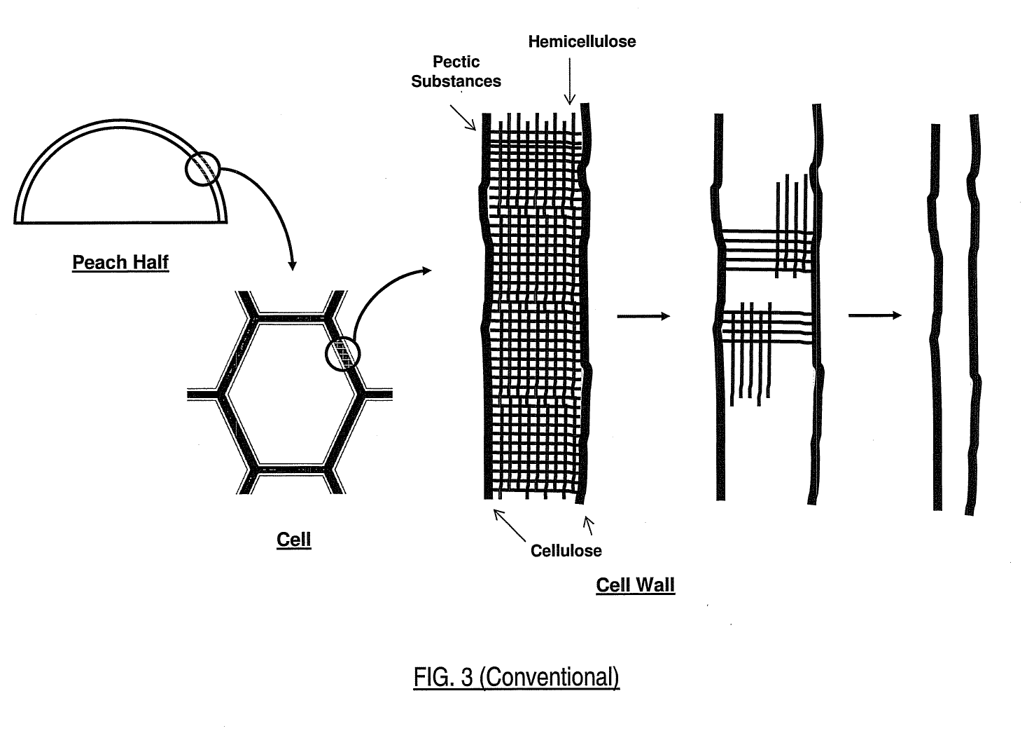

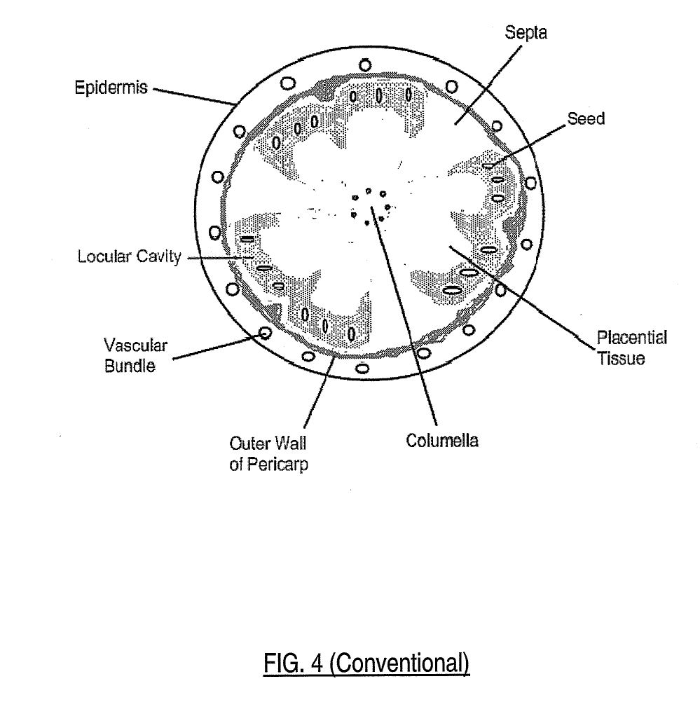

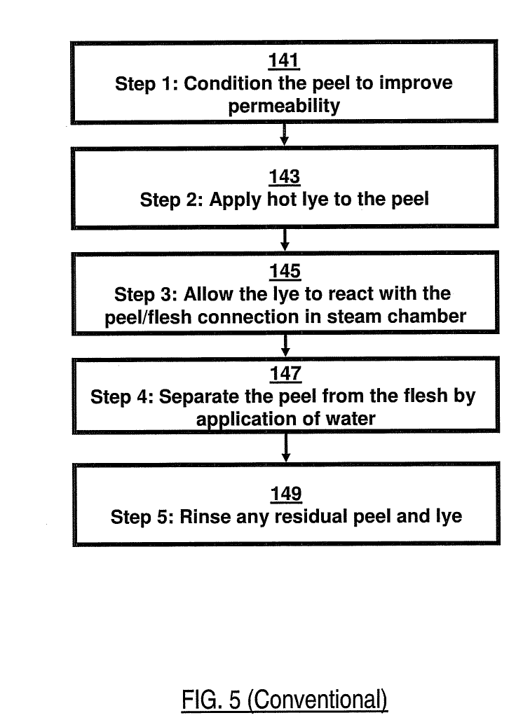

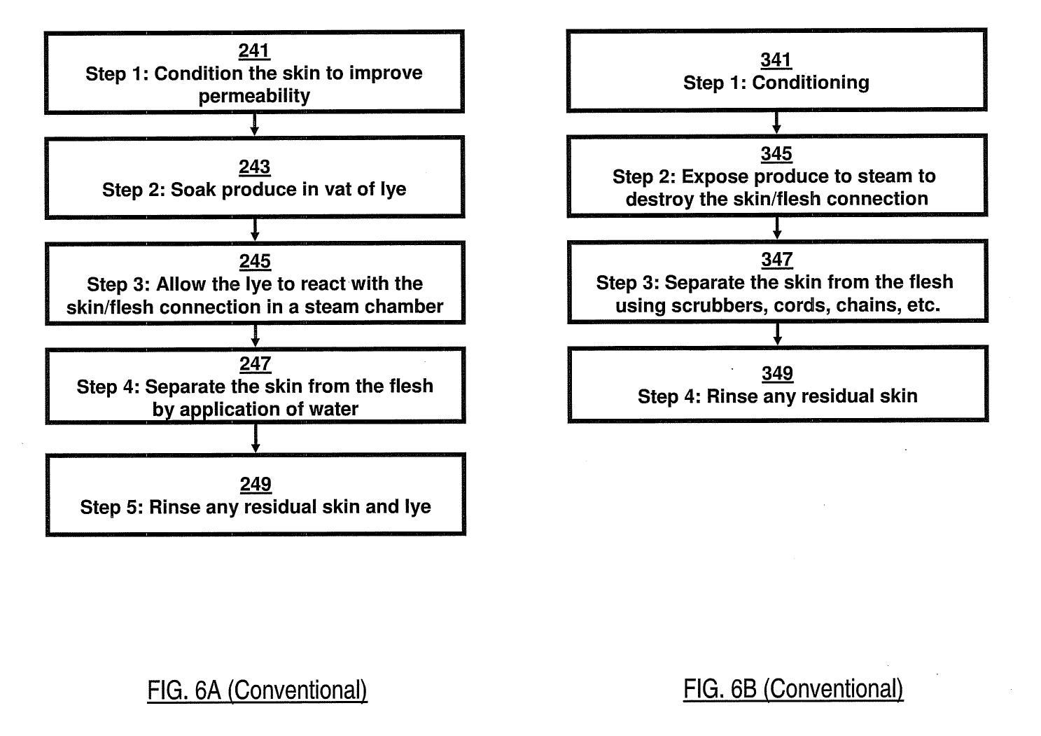

In some embodiments, and referring to the exemplary illustration of FIG. 7, a method for removing the peel of an agricultural produce (for example, and without limitation, a peach) can begin with the optional conditioning step 441 of conditioning the peel. Conditioning ensures, among other things, that the humidity and temperature of the peel and the temperature of the flesh are at conditions suitable for the caustic peeling process. As shown in FIG. 3, the caustic fluid rapidly softens and breaks down the matrix of hemicelluloses and pectic substances between individual cellulose layers. Conditioning may ensure that the subsequently applied caustic fluid will penetrate the peel so that it may interact with the hemicelluloses and pectic substances. Conditioning may also ensure that the flesh of the produce is at a sufficient temperature such that it will not break down, thermally, in subsequent steps. In addition, conditioning may also include raising the surface temperature such that there are minimal thermal losses in the subsequent step of applying the caustic fluid. Thus, in some examples, and without limitation, conditioning may include a first substage where the produce is cooled and a second substage where the produce is subjected to warm (or hot) water or steam. In other examples, conditioning may include mechanically scoring the peel to increase the permeability thereof. It is to be appreciated, however, that other conditioning processes are contemplated in accordance with some embodiments of the present invention.

In some embodiments, after the optional step 441 of conditioning, a method may include application step 443 of applying a caustic fluid to a surface of the peel. In some embodiments, the caustic fluid can be applied on the surface of the peel by one or more misters. However, as discussed more fully below, the produce can be placed in a container filled with the caustic fluid. In some embodiments, the caustic fluid can be lye. For example, the caustic fluid can be sodium hydroxide or potassium hydroxide. However, it is to be appreciated that other caustic fluids are contemplated in accordance with some embodiments of the present invention. In some examples, and without limitation, the caustic fluid can be an about 1% to about 20% solution of sodium hydroxide dissolved in water at between about 65° C. and about 100° C. in temperature. In some examples, and without limitation, the caustic fluid may be applied for a period of between about 5 and about 60 seconds. However, depending on the characteristics of the variety of the produce and the characteristics of the peel, the concentration, temperature, and/or application time of the caustic fluid may be increased or decreased. For example, and without limitation, where the produce is a peach, a 2% solution at 80° C. may be preferred early in the harvest season. But because the peels of peaches typically have increased elasticity towards the end of the harvest season, a 4% solution at 85° C. may be preferred. Similarly, where the produce is a tomato, a 13% solution at 100° C. may be preferred. Thus, it is to be appreciated that other lye solutions, concentrations, temperatures, and application times are contemplated in accordance with some embodiments of the present invention.

After the caustic fluid has been applied to the peel, in some embodiments, a method may include reaction step 445 of allowing the caustic fluid to react with the hemicelluloses and pectic substances. The caustic fluid breaks down the peel and/or the structure between the peel and the flesh of the produce making it easier to separate the outer layer from the flesh of the produce. In some embodiments, the reaction step can include subjecting the produce to heat to increase the temperature of the applied caustic fluid. Thus, in some examples, and without limitation, reaction stage 730 may involve the application of heated steam or air. In some examples, the produce can be subjected to 100° C. steam at atmospheric pressure. In other examples, the reaction step can include subjecting the produce to steam in an airtight chamber at an elevated pressure having a temperature between about 90° C. and about 200° C. It is to be appreciated that, similar to application step 443, depending on the characteristics of the variety of produce and the characteristics of the peel, the temperature of the air or steam and the amount of time that the produce is subjected to the air or steam in reaction step 445 may be increased or decreased. Thus, it is to be appreciated that other reaction temperature and times are contemplated in accordance with some embodiments of the present invention.

It is to be appreciated that as a result of steps 443-445, the hemicelluloses and pectic substances within the cell walls may be substantially broken down thus at least partially destroying the connection between the peel and the flesh of the produce. Thereafter, the peel may easily be removed from the flesh by the application of force thereto. In some embodiments of the invention, removing the peel may include two steps: optional loosening step 446 and separation step 447. In some embodiments, loosening step 446 can include thermal and/or mechanical aid. In some examples, and without limitation, the peel may be loosened by a short burst of hot air or steam. In other examples, the peel may be loosened by vibratory action. In yet other examples, rollers, chains, brushes, cables, cords, or other similar mechanical devices may be caused to come into physical contact with the peel. In other examples, the peel may be gently scored. However, it is to be appreciated that other means of loosening the peel are contemplated in accordance with some embodiments of the present invention.

After the cell walls of the peel itself, or a layer of cells between the peel and the flesh of the produce has been sufficiently destroyed (by one or more of conditioning step 441, application step 443, and reaction step 445), and optionally, loosened (by loosening step 446), the peel and any residual caustic fluid may be substantially removed in a separation step 447. In some advantageous embodiments of the invention, the peel of the produce can be separated from the flesh by the application of one or more forced jets of air to a surface of the peel. In some examples, without limitation, and as discussed more fully below, one or more peelers in the form of rotating, contoured, of flat peelers, each peeler having one or more nozzles, can be configured to receive air from an air supply and direct it towards a portion of the produce. In some embodiments, and discussed more fully below, a small amount of fluid may be injected into the jet of air or applied to a surface of the peel to assist in the separation process.

It is to be appreciated that, in preferred embodiments, the jet of air applied to the peel in separation step 447 has sufficient kinetic energy to substantially remove the entire peel from the produce. However, it is to be appreciated that less than all of the peel may be removed. It is also to be appreciated that residual traces of caustic fluid may be present on the flesh of the produce. Thus in some embodiments, the method may include the optional rinsing step 449 for applying a small amount of fluid to the produce to rinse the produce of any residual peel or caustic fluid not sufficiently removed in separation step 447. In some examples, and without limitation, the fluid may comprise water. However, it is to be appreciated that other fluids are contemplated in accordance with some embodiments of the present invention. Preferably, the volume of fluid used in rinsing step 449 is minimal and may be applied by misters or atomizing devices.

It is to be appreciated that, the present invention is directed towards removing the peel or skin of produce using forced air. As above, in some embodiments, a connection between the peel and the flesh of the produce may be at least partially destroyed by applying a caustic fluid to the peel by applicators. However, it is to be appreciated that other methods of destroying the connection between the peel/skin and the flesh of the produce are contemplated in accordance with some embodiments of the present invention.

Referring now to the exemplary illustration of FIG. 8A, a method for removing the skin of an agricultural produce (for example, and without limitation, a tomato) can begin with the optional conditioning step 541 of conditioning the skin. Next, and as discussed more fully below, methods can include a soaking step 543 where the produce is deposited into a vat or other container filled with the caustic fluid. In some embodiments, the method may include the optional reaction step 545 where the caustic fluid is allowed to react with the connection between the skin and the flesh of the produce. As above, in some examples, and without limitation, reaction step 545 can include subjecting the produce to heat and/or steam. In advantageous embodiments of the invention, after the connection has been sufficiently destroyed, the method can include separation step 547 where the skin is separated from the flesh by the application of one or more forced jets of air to the surface of the skin. In some examples, and without limitation, one or more rotating, contoured, or flat peelers may receive air from an air supply and direct it towards a surface of the skin of the produce. In some embodiments, after the skin has substantially been substantially removed in separation step 547, the method can include the optional rinsing step 549 where a rinsing fluid can be applied to the peeled produce.

Although the above examples refer to methods for destroying the connection between the peel and the flesh of the produce by application of a caustic fluid, it is to be appreciated that some embodiments of the present invention contemplate other methods for destroying the connection between the peel and the flesh. In some embodiments, the connection may be destroyed by heat and/or steam. Referring now to the exemplary illustration of FIG. 8B, methods for destroying the skin/flesh connection of a produce (for example, and without limitation, a tomato) can include exposing step 645 where the produce is exposed to steam. In some examples, and without limitation, after optional conditioning step 641, the produce can be transferred into a steaming chamber for a period of time sufficient to destroy the skin/flesh connection. Thereafter, the loosened skin can be removed from the produce by separation step 647, wherein a directed jet of forced air is applied to a surface of the skin. In some embodiments, and as discussed more fully below, separation step 647 can additionally include causing mechanical loosening means (such as rubberized cords) to come into contact with the loosened skin to assist in the separation process.

Exemplary Produce Peeling Processes

It is to be appreciated that some preferred embodiments of the invention concern continuous processes using a jet of air to separate the outer peel or skin of an agricultural produce from the inner fleshy portion. In some embodiments, the connection between the peel and the flesh can be destroyed by exposing the produce to steam. It is to be appreciated that one benefit realized by using a jet of air to separate the peel from the flesh, instead of water conventionally, is a reduction in both freshwater requirements and wastewater generation. Thus, it is to be appreciated that freshwater usage should be minimized in accordance with some embodiments of the present invention. It is further to be appreciated that, in accordance with some embodiments of the present invention, the process byproducts should be reused or recycled back into the process to the greatest extent possible.

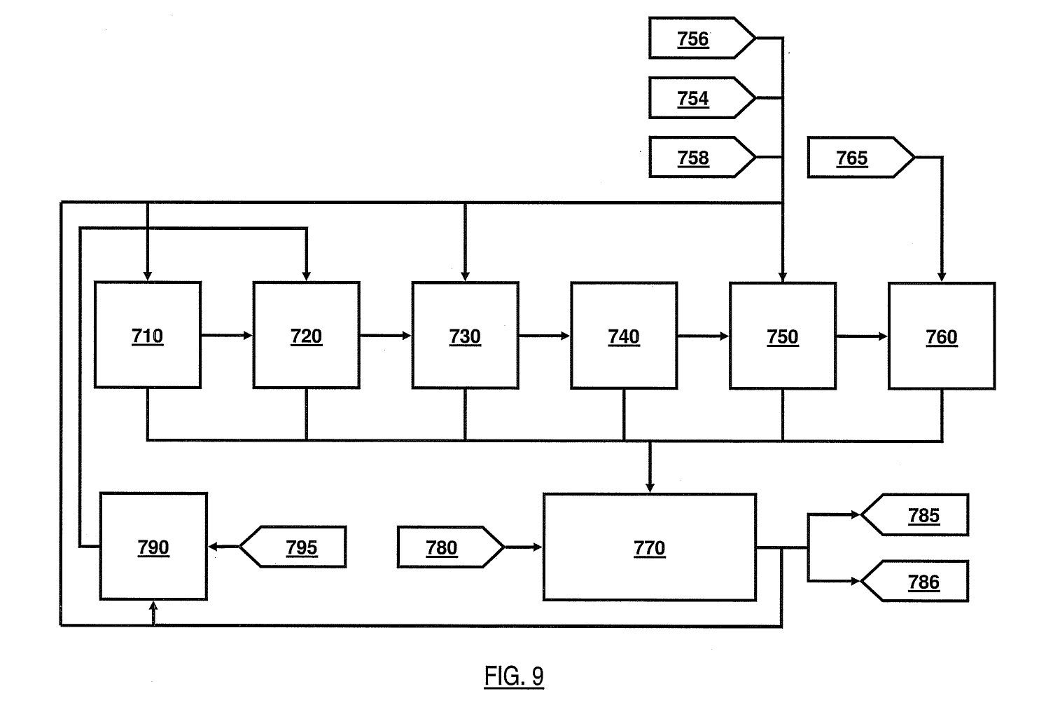

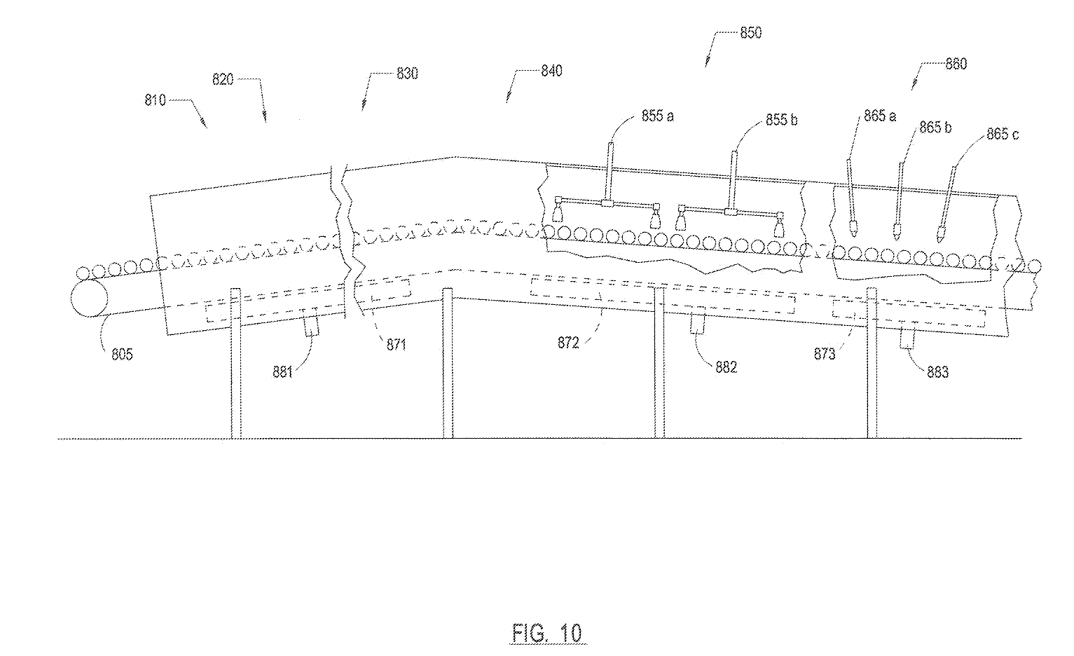

Referring now to the exemplary diagram of FIG. 9, and without limitation, a process can include a plurality of stages or processes, each as described more fully herein. In some embodiments, an agricultural produce can be processed sequentially by each conditioning stage 710, application stage 720, reaction stage 730, loosening stage 740, separating stage 750, and rinsing stage 760. However, in some embodiments, peeling processes need not employ each stage. As above, one or more of conditioning stage 710, reaction stage 730, loosening stage 740, and rinsing stage 760 may be optional. For example, and without limitation, loosening stage 740 may be optional, in which case produce may be sequentially proceed by reaction stage 730 and then separating stage 750.

As above, in some embodiments, a connection between the peel and the flesh can be destroyed by exposing the produce to a caustic fluid, which in some examples, and without limitation, can be applied by an applicator or by soaking the produce in a vat containing the caustic fluid. In some embodiments, application stage 720 can include applying a caustic fluid to a surface of the peel of the produce by one or more applicators. In some other embodiments, application stage 720 can include depositing the produce in a vat containing the caustic fluid. In some examples, and without limitation, the caustic fluid can include a lye solution, such as sodium phosphate or potassium phosphate. In some other embodiments, destruction stage 720 can include exposing the produce to steam.

In some embodiments, discharge or byproduct of the individual stages can be received by a recycling stage 770 for processing thereof. However, it is to be appreciated that, in some embodiments, discharges from the individual stages need not each be received by recycling stage 770. In some embodiments, a plurality of recycling stages can be provided. For example, and without limitation, recycling stage 770 can receive discharge from separation stage 750 and rinsing stage 760 and a second recycling stage (not shown) can receive discharge from application stage 720 and reaction stage 730. In some embodiments, peeling process can also include a caustic adjusting stage 790, as discussed more fully below. It is to be appreciated that the stages of systems in accordance with some embodiments of the present invention contemplate other inputs and outputs.

In some embodiments, one or more processing stages can receive an output from recycling stage. For example, and without limitation, conditioning stage 710, reaction stage 730, separating stage 750, rinsing stage 760, and caustic adjusting stage 790 can each receive an output from recycling stage 770. In some examples, application stage 720 can receive an output from caustic adjusting stage 790, discussed below. However, it is to be appreciated that other processing configurations are contemplated in accordance with some embodiments of the present invention. It is further to be appreciated, that the processing stages can receive additional inputs in accordance with some embodiments of the present invention. For example, and without limitation, in addition to or exclusive of an output from recycling stage 770, conditioning stage 710 can further receive a freshwater supply (not shown).

In some preferred embodiments, discussed more fully herein, the peel of the produce may be separated by one or more peelers configured to direct a jet of air towards a surface of the peel. Thus, in some embodiments, separation stage 750 may receive an output from air supply 756 for providing the same to the peelers. In some embodiments, the air supply can comprise a blower. For example, and without limitation, air supply 756 can comprise a blower configured to draw in ambient air from the environment. In some examples, and without limitation, the blower can be configured to draw air from an area immediately near to a peeling system. It is to be appreciated however that the blower can be configured to draw air from an area located a distance from the peeling system. For example, and without limitation, a blower can be configured to draw air from a vent in fluid communication with the environment outside of a facility in which the peeling system is enclosed.

In some embodiments, the air supply can comprise a compressor. For example, and without limitation, air supply 756 can comprise a compressor and corresponding tank for generating and providing compressed air. In some embodiments, air supply 756 can include compressed air at between about 30 and about 150 PSI. In some embodiments, the amount of compression can be configurable based on processing parameters. For example, and without limitation, the amount of compression may be configured based on the type and quality of the produce. However, it is to be appreciated that other amounts of compression are contemplated in accordance with some embodiments of the present invention. It is further to be appreciated that the compression amount may be fixed, or may be adjustable depending on, among other things, the type and quality of the produce to be peeled.

In some embodiments, the peel of the agricultural produce may be removed utilizing air fortified with one or more elemental or manufactured gasses. Thus in some embodiments, the air supply can additionally include one or more pressurized containers of elemental or manufactured gasses which may be mixed with air from a blower or compressor. In some examples, and without limitation, the gas in air supply 756 may comprise hydrogen, nitrogen, carbon dioxide, sulfur dioxide, ozone, and the like. It is to be appreciated that, in some embodiments, the gas can be selected to preserve and/or prevent oxidation of the peeled produce. For example, and without limitation, air supply 756 can include a compressor providing compressed air and a pressurized container of carbon dioxide.

In some embodiments, apparatuses and systems can further include means for blending air from one or more blowers, compressors, and the like and gas from one or more pressurized containers and the like. For example, and without limitation, separation stage 750 can include a gas mixing chamber for mixing air from a compressor and pressurized carbon dioxide gas. In some examples, and without limitation, air from a blower can be mixed with pressurized sulfur dioxide through a common port of a peeler used in separation stage 750. It is within the abilities of those in the art to implement blending and/or mixing of air and/or gasses in accordance with embodiments of the present invention.

As discussed more fully herein, in some embodiments, apparatuses and systems may further comprise conditioning means associated with separation stage 750, such as, and without limitation, temperature and humidity control means. For example, and without limitation, air supply 756 and/or a peeler used in separation stage 750 may include thermal elements for modulating a temperature of the air used to remove the peel of the produce. In some examples, and without limitation, the air may be maintained at about 55 degrees Fahrenheit. However, other temperatures are contemplated in accordance with some embodiments of the present invention. In some examples, air supply 756 and/or a peeler used in separation stage 750 may include humidification means for modulating the moisture content of the air. For example, and without limitation, the air may be maintained between about 50 and about 95 percent humidity. However, it is to be appreciated that other temperatures, humidity ranges and processing parameters are contemplated in accordance with some embodiments of the present invention. It is further to be appreciated that the conditioning means may have fixed process variables, or may be adjustable depending, among other things, the type and quality of the produce to be peeled.

In some embodiments, apparatuses and systems may further comprise means for inhibiting microbial, viral, bacterial development and/or growth. Thus in some examples, and without limitation, air supply 756 may comprise means for generating ozone or for ionizing the air provided to a peeler used in separation stage 750. In other examples, one or more other stages, including but not limited to loosening stage 740, removal stage 750, and rinsing stage 760 may include devices for ionizing the localized environment or for subjecting the produce to ultraviolet light. However, it is to be appreciated that other antimicrobial, antiviral, and antibacterial means are contemplated in accordance with some embodiments of the present invention.

It is to be appreciated that in some applications the exertion of forced air on the produce may dry out the peel, causing it to be more difficult to remove from the flesh. In some embodiments, and as discussed more fully herein, separation of the peel from the flesh may be enhanced by injecting a fluid into the air stream. Thus, in some embodiments, separation stage 750 may receive an output from fluid supply 758. In some embodiments, a peeler used in separation stage 750 may be configured to receive a small amount of fluid from fluid supply 758 in the form of a pressurized mist or steam. In some examples, and without limitation, fluid supply 758 may provide a small amount of cold or warm water which may be injected into the forced air stream via a mixer between the air supply 756 and the peeler used in separation stage 750. In some examples, fluid supply 758 may provide steam or atomized fluid which may be injected into the forced air stream through a supply line leading from air supply 756 to the peeler used in separation stage 750. Thus, it is to be appreciated that fluid supply 758 may be a steam generator, a cold-temperature humidifier, a water pump, and the like. It is to be appreciated various fluids are contemplated in accordance with some embodiments of the present invention. For example, and without limitation, fluid supply 758 may provide water, an aqueous sucrose solution, an aqueous acid solution (such as, for example, and without limitation, ascorbic or citric acid), neutralizing agents and combinations thereof.

In some embodiments, and as discussed more fully herein, separation of the peel from the flesh may be enhanced by applying a fluid onto a surface of the peel. Thus, in some embodiments, separation stage 750 may receive an output from fluid supply 754. In some embodiments, fluid provided by fluid supply 754 may be applied directly to the surface of the produce, independently from a fluid which may be provided by fluid supply 758. In some examples, and without limitation, fluid from fluid supply 754 may be applied to the produce before, after, or contemporaneously with the application of a forced jet of air from a peeler in separation stage 750. In some examples, and without limitation, fluid from fluid supply 754 may be in the form of a small mist of water or citric acid applied to the produce by one or more misters located adjacent to the peeler. In some other examples, fluid from fluid supply 754 may be in the form of a steam curtain. It is to be appreciated that other fluids are contemplated in accordance with some embodiments of the present invention.

As discussed more fully herein, in some embodiments, apparatuses and systems may further comprise a final rinsing stage for removing any residual peel and/or caustic fluid. Thus, in some embodiments, rinsing stage 760 may receive an output from fluid supply 765. It is to be appreciated that the amount of fluid may be minimal. In some embodiments, between about 1 and about 3 GPM may be sufficient. In some embodiments, between about 0.3 to 1.0 GPM per short ton of produce may be sufficient. It is further to be appreciated that rinsing stage 760 may comprise a multiple sub-stages. For example, and without limitation, rinsing stage 760 may comprise a first sub-stage and a second sub-stage. The first sub-stage may comprise an initial rinsing of the produce (with a comparatively larger amount of fluid) and a second sub-stage which may comprise a final rinsing. It is to be appreciated that in some embodiments, the only freshwater that is consumed by the peeling process includes fluid from fluid supply 765. However, in some embodiments, separation stage 750 may also receive freshwater from fluid supply 758 and/or fluid supply 754.

In some embodiments, and as shown in the exemplary illustration of FIG. 9, the discharge or byproduct from the conditioning stage 710, application/destruction stage 720, reaction stage 730, loosening stage 740, separation stage 750, and rinsing stage 760 may be received by recycling stage 770. In some embodiments, the byproduct can include caustic fluid, portions of the removed peels and other organic solids, and the liquid which may be added to the system in the various stages. In some embodiments, the fluid from fluid supply 765 used in rinsing stage 760 can also be received by recycling stage 770. In some embodiments, the fluid from fluid supply 765 used in rinsing stage 760 may be recovered separately and recycled back for use in rinsing stage 760. However, it is to be appreciated that some embodiments of the present invention contemplate collecting waste from any number of stages in any number of recovery containers. For example, and without limitation, waste from conditioning stage 710 and rinse stage 760 may be collected together, waste from application stage 720 and reaction stage 730 may be collected together, and waste from loosening stage 740 and removal stage 750 may be collected together.

In some examples, and without limitation, recycling stage 770 may mix, pulverize, press, and/or filter the discharge so as to separate the caustic fluid, liquid, and/or solid portions. In some examples, recycling stage 770 can neutralize and process via by processing agent 780 the discharge so as to provide environmentally safe and beneficial products. The specific characteristics of processing agent 780, solid waste 785, and liquid waste 786 from recycling stage 770 depends, among other things, on the type and concentration of caustic fluid applied, if any, in application/destruction stage 720. In some examples, and without limitation, the caustic fluid used in application stage 720 may be selected such that the recovered peel can be neutralized to produce safe byproducts, such as peel salt 785. For example, sodium hydroxide (NaOH) can be used as the caustic fluid and food grade hydrochloric acid (HCl) may be used as the neutralization agent 780. The chemical reaction between sodium hydroxide and hydrochloric acid results in the production of water (H₂O) and sodium chloride (NaCl). Thus, in some examples, the complete byproducts of a process in accordance with some embodiments of the present invention are fruit peel, salt (NaCl), and water. Solid 785 (which in some examples, and without limitation, may be peel salt) may then safely be fed to animals. In other examples, potassium hydroxide (KOH) can be used as the lye. The chemical reaction between potassium hydroxide and hydrochloric acid results in the production of water and potassium chloride. The potassium chloride and peel may be dispensed on the land as safe and effective fertilizer and the water may be recycled back into the system. In other examples, pectin may be produced from the discharge recovered from separation stage 750. It is to be appreciated that other combinations of caustic fluids and neutralizing agents are contemplated in accordance with some embodiments of the present invention.

In addition to the above realized benefits, because little water is added to the system, the liquid recovered and separated from the solids by recycling stage 770 may be substantially caustic fluid that has been minimally diluted from the concentration as it was applied in application stage 720. In some examples, and without limitation, this recovered caustic fluid can be recycled and reused in application stage 720. As such, in some embodiments, byproducts of a process in accordance with some embodiments of the present invention may be (i) recovered caustic fluid that has been minimally diluted and (ii) byproducts which may neutralized and/or processed to produce, in some examples, and without limitation, water, peel, salt, and/or pectin.

In some embodiments, the caustic fluid recovered recycling stage 770 can be used in a caustic adjustment stage 790. Concentrated caustic fluid 795 may also be utilized by caustic adjustment stage 790 such that the concentration of caustic fluid that is applied in application stage 720 remains nearly constant. In some examples, and without limitation, the concentration of caustic fluid may also be adjusted in caustic adjustment stage 790 by partially evaporating an output of recycling stage 770 before it is reused in application stage 720. It is to be appreciated that evaporation of the wastewater may remove a substantial portion of the water thereby increasing the concentration of caustic fluid. In some examples, and without limitation, caustic adjustment stage 790 can include titration of the wastewater from recycling stage 770 to determine the concentration of caustic fluid which will indicate whether any adjustments are necessary. It is to be appreciated that other means of adjusting the concentration of caustic fluid are contemplated in accordance with some embodiments of the present invention.

It is to be appreciated, however, that in accordance with some embodiments of the present invention, the water and/or liquid recovered in any stage may be recycled for use in that or any other stage. For example, and without limitation, water recovered and recycled from separation stage 750 and rinse stage 760 can be used in conditioning stage 710, reaction stage 730, and separation stage 750. It is also to be appreciated that numerous modifications are contemplated in accordance with some embodiments of the present invention.

Exemplary Peeling Systems

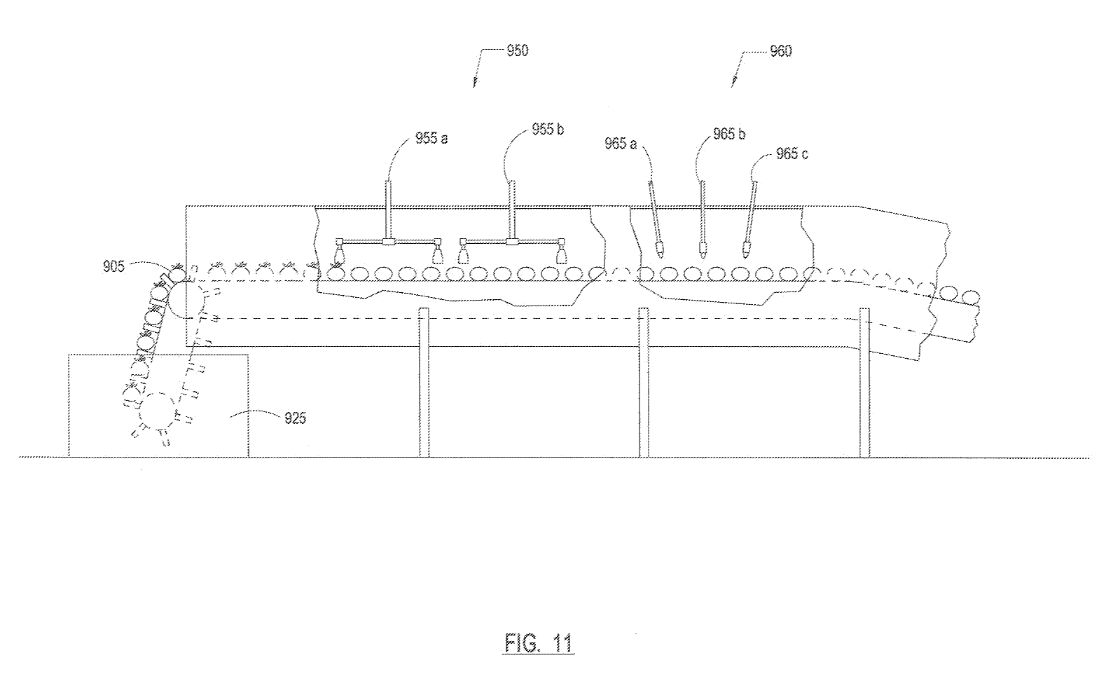

Referring now to the exemplary illustration of FIG. 10, and without limitation, an unpeeled produce (for example, and without limitation, a peach) may be placed on a conveyor 805 which is configured to continuously transport the peach through different stages of a system. In some embodiments, the produce is washed, cut in half, and pitted prior to being placed on conveyor 805. Conveyor 805 may continuously move the produce through one or more of conditioning stage 810, application stage 820, reaction stage 830, loosening stage 840, separation stage 850, and rinsing stage 860, each of which are more fully discussed herein.

In some examples, and without limitation, conveyor 805 may comprise a single belt. Conveyor 805 may operate at a fixed speed or may have several operable speeds and may be configured to intermittently stop for a predetermined period. In some examples, and without limitation, conveyor 805 can have multiple speeds ranging from between about 0.025 feet per second and about 1.0 foot per second. In some examples, and without limitation, conveyor 805 may include ribbed, recessed, and/or protruding portions to stabilize the produce as it moves through the various stages. Is some embodiments, the conveyor may comprise multiple belts. For example, and without limitation, conveyor 805 may have a first belt configured to operate at a first speed through a first portion of the system and a second belt configured to operate at a second speed through other portions of the system.

In some embodiments, conveyor 805 may move the produce in a direction parallel to the floor upon which the system sits. In other embodiments, conveyor 805 may move the produce at an incline and/or decline. For example, and without limitation, conveyor 805 may move the produce upwards at an angle of between 0 and 30 degrees relative to the floor. In other examples, conveyor 805 may move the produce at different angles through different portions of the system. For example, and without limitation, conveyor 805 may move the produce upwards at an angle of 20 degrees through a conditioning stage 810, an application stage 820, and a reaction stage 30, and downwards at an angle of 5 degrees through a loosening stage 840, a separation stage 850, and a rinse stage 860. However, it is to be appreciated that other speeds and angles of conveyor movement are contemplated in accordance with some embodiments of the present invention. It is further to be appreciated, and as discussed more fully below, conveyor 805 need not be configured to operate in a straight line. Rather, in some examples, and without limitation, conveyor 805 may be configured with one or more bends or have a helical configuration for transferring the produce between vertically positioned stages.

As the produce is moved along conveyor 805, it may first be conditioned by conditioning stage 810 to ensure, among other things, that the humidity and the temperature of the peel and the temperature of the flesh are at conditions suitable for the peeling process. In some examples, and without limitation, conditioning stage 810 can include means for generating steam. Next, the produce can be moved by conveyor 805 to an application stage 820. In some examples, and without limitation, application stage 820 can include a plurality of applicators for spraying a caustic fluid (such as, for example, and without limitation, aqueous lye) on the peel of the produce. Next, the produce can be moved by conveyor 805 to a reaction stage 830. In some examples, and without limitation, reaction stage 830 can include means for generating steam. Next, the produce can be moved by conveyor 805 to a loosening stage 840. In some examples, and without limitation, loosening stage 840 can include one or more mechanical devices (such as, for example, and without limitation, rubber cords) for contacting a portion of the peel of the produce. In some other examples, loosening stage 840 can include means for scoring or slitting a portion of the peel of the produce.

In some embodiments, the produce can then be moved by conveyor 805 to a separation stage 850. In some embodiments, separation stage 850 can include a plurality of peelers for forcibly directing a jet of air towards a surface of the peel of the produce. For example, and without limitation, rotating peelers 855a-855b may be positioned above a portion of conveyor 805. It is to be appreciated that, in some embodiments, as produce moves along conveyor 805, a connection between the peel and the flesh may be destroyed by a caustic fluid at application stage 820 and/or reaction stage 830, after which one or more forced jets of air from peelers 855a-855b may substantially separate the peel from the flesh. In some examples, and without limitation, separation stage 850 can include a single peeler. In other examples, separation stage 850 can include a plurality of series and/or parallel peelers. In addition, as discussed more fully below, separation stage 850 may include one or more fluid applicators for applying a mist of fluid to a surface of the produce to prevent the peel from drying out.

In some embodiments, the produce can then be moved by conveyor 805 to a rinsing stage 860. In some embodiments, rinsing stage 860 can include a plurality of misters, nozzles, or applicators for applying a small amount of water to the surface of the produce. In some examples, and without limitation, rinsing stage 860 can include a single mister. In other examples, rinsing stage 860 can include a plurality of series and/or parallel misters. For example, and without limitation, misters 865a-855c may be positioned above a portion of conveyor 805 for spraying a top portion of the produce. In some examples, and without limitation, one or more misters may be angled perpendicular to conveyor 805. However, in some other examples, one or more misters may be configured such that the water may be applied to a side of the produce. In some examples, and as illustrated in FIG. 10, one or more of the misters may be slightly angled with respect to each other and conveyor 805.

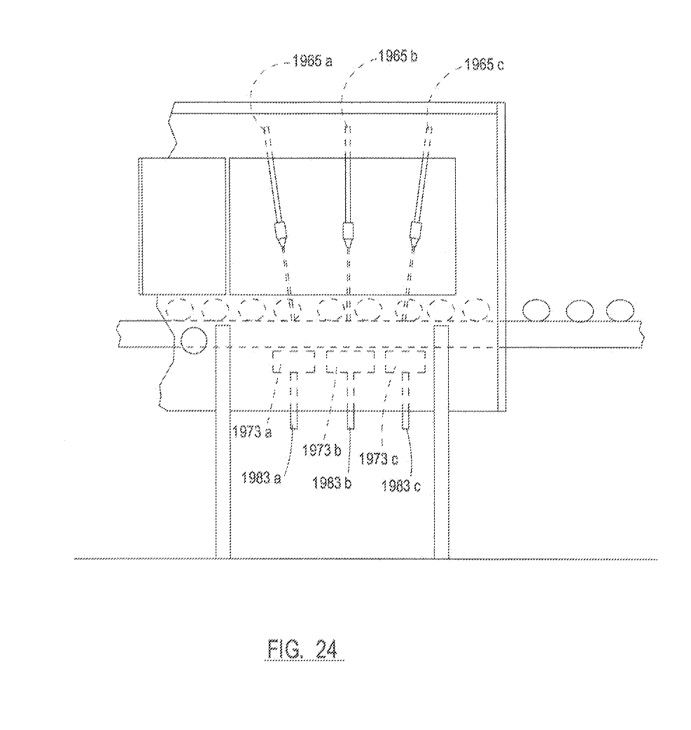

In some embodiments, the discharge from the processing stages can be collected and provided to a recycling system. In some embodiments, discharge from several stages can be collected together. For example, and without limitation, discharge from conditioning stage 810, application stage 820, and reaction stage 830 can be collected by a pan 871 and a corresponding port 881. In some examples, a hose or pipe can be attached to port 881 for transferring the discharge to the recycling system. In some embodiments, each stage may have a separate discharge collection. For example, and without limitation, separation stage 850 can include a first recovery pan 872 and recycling stage 860 can include a second recovery pan 873. In some preferred embodiments, a single stage may include a plurality of separate discharge collections. Referring to the exemplary illustration of FIG. 24, and without limitation, a rinsing stage can include a plurality of fluid applicators 1965a-1965c, and corresponding recovery pans 1973a-1973c and ports 1983a-1983c. In some embodiments, fluid applicator 1665c may be configured to spay a mist of freshwater on the surface of the produce. The discharge or wastewater from this stage can be recovered in pan 1973c, collected through port 1983c, and recycled for use by applicator 1965b. It can be appreciated that the fluid sequentially applied to the produce by fluid applicators 1965a-1965c becomes increasingly cleaner.

As shown in the exemplary illustration of FIG. 10, some systems in accordance with embodiments of the present invention can include an application stage 820 for spraying a caustic fluid on the surface of the peel. However, it is to be appreciated that some embodiments of the present invention concern exposing the produce to steam to destroy the connection between the peel and the flesh of the produce. Thus, in some examples, and without limitation, destruction stage 820 can include means for subjecting the produce to steam. Similarly, other embodiments of the present invention concern soaking the produce in a vat or container of a caustic fluid to destroy the connection between the peel and the flesh.

Referring now to the exemplary illustration of FIG. 11, systems can include a vat or container 925 at least partially filled with a caustic fluid. In some embodiments, the produce may be placed in a container 925 of caustic fluid (for example, and without limitation, an aqueous lye solution). In some embodiments, conveyor 905 may be configured to receive the produce from the vat 925 and move it along a peeling system. Similar to as described above, one or more peelers 955a and 955b may be configured to direct a jet of forced air across a portion of the peel of the produce in a separation stage 950. In some examples, and without limitation, conveyor 905 may be configured parallel to the horizontal floor surface. In other examples, the conveyor may be configured at a slight angle (for example, and without limitation, of five degrees) to facilitate rotation. In some embodiments, as discussed more fully herein, separation stage 850 may include one or more fluid applicators for injecting a fluid in the forced air or applying a mist of fluid to a surface of the produce to prevent the peel from drying out. In some embodiments, the system may also include a rinsing stage 960 including one or more misters 965a-965c for rinsing the produce.

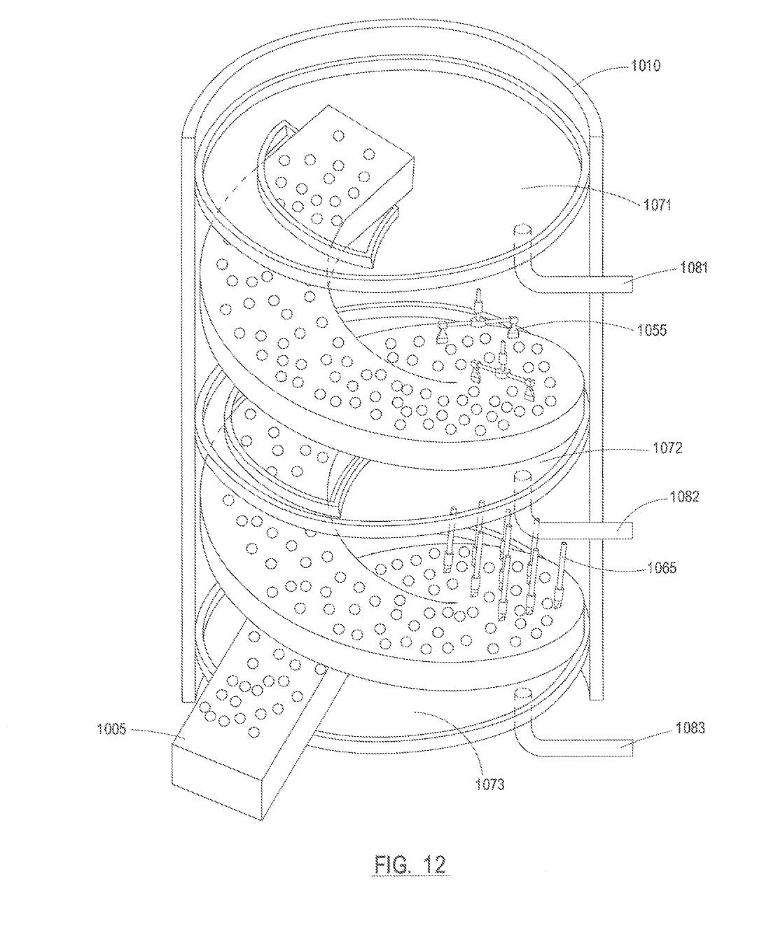

As illustrated in the examples of FIGS. 10-11, in some embodiments, each stage of the system may be vertically adjacent to each other. However, in some embodiments the stages can be arranged vertically. Referring to the exemplary illustration of FIG. 12, and without limitation, a system can include one or more conveyors 1005 for moving the produce sequentially through vertically arranged stages. In some examples, and without limitation, conveyor 1005 may comprise a continuous helical-type conveyor operable throughout each stage of the system. In other examples, conveyor 1005 may comprise a plurality of individual conveyors and transfer units. In some embodiments, each stage may be isolated from the others. For example, and without limitation, a thermal and/or physical barrier 1072 may be placed between the separation stage (including, for example and without limitation, one or more peelers 1055) and rinsing stage (including, for example and without limitation, one or more misters 1065). In some embodiments, openings may be provided in the barriers for transferring produce there between on conveyor 1005. In some embodiments, the entire system may further be thermally insulated. For example, and without limitation, a thermal shield 1010 may be placed around the vertically oriented stages. However, it is to be appreciated that other orientations and/or configurations of the various stages as discussed herein are contemplated in accordance with some embodiments of the present invention.

In some embodiments, the discharge from each stage may be collected and recycled. Thus, the barriers may include pans and corresponding ports for collecting and transferring discharge. For example, and without limitation, waste from the caustic fluid application and/or reaction stages may be collected by pans in barrier 1071 and transferred through corresponding port 1081. Similarly, discharge from the separation and rinsing stages can be collected by pans in barriers 1072 and 1073, respectively.

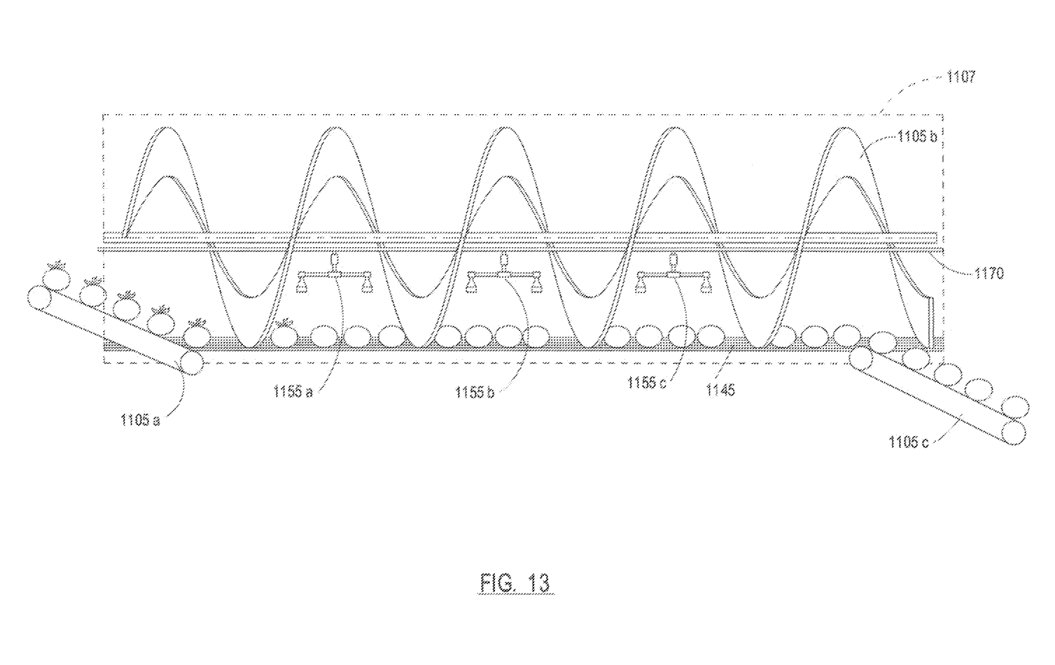

As illustrated in some of the above examples, the stages of a peeling process can be physically separate. However, in some embodiments, one or more peeling stages may be combined into a single portion of a system. Referring to the exemplary illustration of FIG. 13, and without limitation, several stages of a system may be enclosed in a drum 1107. A first conveyor 1105a may transport the produce into drum 1107. In some embodiments, within drum 1107, one or more peelers 1155a-1155c may be engaged with a supply conduit 1170 for delivering air and optionally fluid to the peelers. A screw 1105b may be provided for moving the produce through loosening means 1145. A second conveyor 1105c may be provided for removing the produce from loosening means 1145 and, generally, drum 1107. In some examples, and without limitation, loosening means 1145 may comprise one or more rubberized cords for applying friction to the produce as it is forced along by screw 1105b. In some embodiments, fluid applicators (not shown) may also be provided.

It is to be appreciated the examples above illustrate some exemplary embodiments of systems in accordance with the present invention which use a caustic fluid, steam, and rotating peelers for removing the peel or skin from the flesh of agricultural produce. However, it is within the abilities of those in the art to modify the disclosure herein to implement other systems for peeling agricultural produce by using a forced jet of air. For example, and without limitation, the example of FIG. 10 can be modified to include contoured peelers instead of rotating peelers.

Exemplary Rotating Peelers

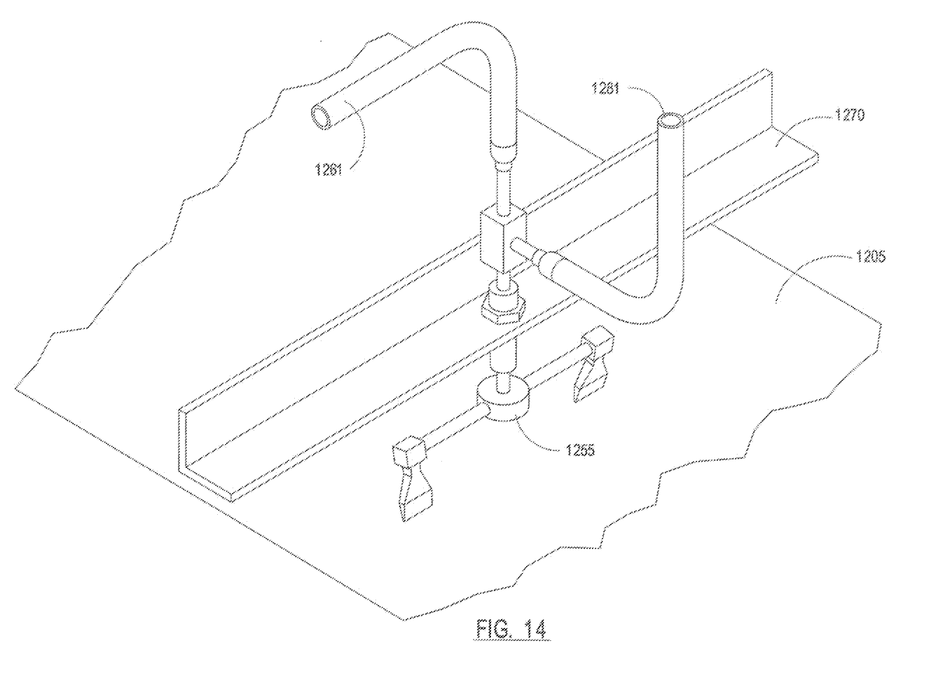

In some preferred embodiments, and without limitation, systems and apparatuses may include peelers having one or more nozzles which are rotatable around a central axis. For example, and without limitation, referring generally to the examples of FIGS. 14-19, a peeler may include a plurality of nozzles operatively engaged with a central manifold via at least one arm. It is to be appreciated that removal of the peel of the produce in accordance with some embodiments of the present invention is accomplished by subjecting the produce to one or more jets of forced air from one or more rotating or swiveling peelers, wherein each time a nozzle of the peeler passes over the produce, a small section of the peel is removed. In some embodiments, and as discussed more fully below, additional fluid may be added to the jet of air. The forced air and optional fluid can be configured with a velocity and volume sufficient to separate a portion of the peel from the flesh. For example, referring to FIGS. 14-16, and without limitation, a leading edge of the produce may move via conveyor 1205 underneath rotating peeler 1255 having nozzles 1202a and 1202b with distal vents for exhausting forced air and/or fluid along projections 1222a and 1222b, respectively. As the produce continues to advance on conveyor 1205, additional portions of the peel of the produce may be sequentially removed by the forced air and optional fluid from rotating peeler 1255.

It some examples, and without limitation, two nozzles 1202a and 1202b may be provided at distal ends of arms 1203a and 1203b, respectively, each arm being operatively engaged with manifold 1206. However, it is to be appreciated that peelers having other numbers of arms are contemplated in accordance with some embodiments of the present invention. For example, as shown in the example of FIG. 17, and without limitation, four arms each having a nozzle on a distal end thereof may be provided. In other examples, three arms each having a nozzle on a distal ends thereof may be provided. It is to be appreciated however, that the arms need not have the same length. For example, and without limitation, a peeler can include four arms, two of which have a first length and two of which have a second length.

In some examples, and without limitation, a peeler may have a single nozzle on a distal end of each arm. However, it is to be appreciated that any number of nozzles may be provided on an arm. For example, and without limitation, two nozzles may be provided, each at a distal end of the arm. It is further to be appreciated that the nozzles need not be provided on distal ends of the arms. For example, and without limitation, a first nozzle can be provided at a distal end of the arm while a second nozzle can be provided along the arm between the distal end thereof and the manifold. In some examples, a secondary arm (not shown) may be provided at a distal end of the primary arm extending from the manifold. For example, and without limitation, the secondary arm may be generally perpendicular to the primary arm, and at least one nozzle may be provided at each end of such secondary arm. In other examples, the primary arm can be coupled to the secondary arm through a secondary swivel assembly. In such examples, the entire peeler may rotate about an axis through the primary swivel assembly, and the secondary arm having nozzles at ends thereof rotates about an axis at a distal end of the primary arm. It is also to be appreciated that, in some embodiments of the present invention, at least one nozzle may be engaged with and extend below the manifold. It is also to be appreciated that a secondary manifold (not shown) may be provided adjacent to and below the primary manifold. In some examples, and without limitation, the secondary manifold may be configured with at least one arm extending there from. It is to be appreciated that other configurations are contemplated in accordance with some embodiments of the present invention.

In some embodiments, peeler 1255 may be mounted on a frame 1270 disposed above conveyor 1205 via swivel assembly 1211/1212. The swivel assembly 1211/1212 may provide for rotational motion while allowing manifold 1206 to be operatively engaged to intake port 1207. In some examples, and without limitation, intake port 1207 may be adapted for engagement to an air supply (for example, and without limitation, air supply 756 as shown in FIG. 9) and optionally a fluid source (for example, and without limitation, fluid source 758 as shown in FIG. 9). In some embodiments, intake port 1207 can be engaged to mixer 1230 receiving air through supply line 1261 and fluid through supply line 1281. However, it is to be appreciated that, in some embodiments, peelers may not be adapted to receive fluid 758. Thus in some examples, and without limitation, intake port 1207 can be directly engaged to supply line 1261 for receiving air therefrom.

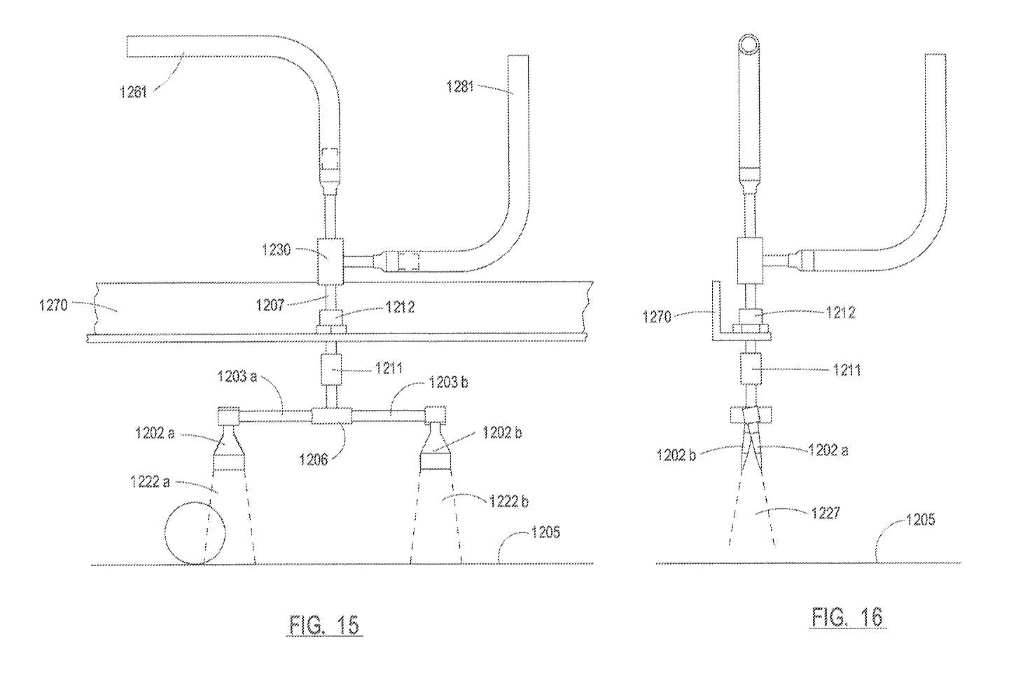

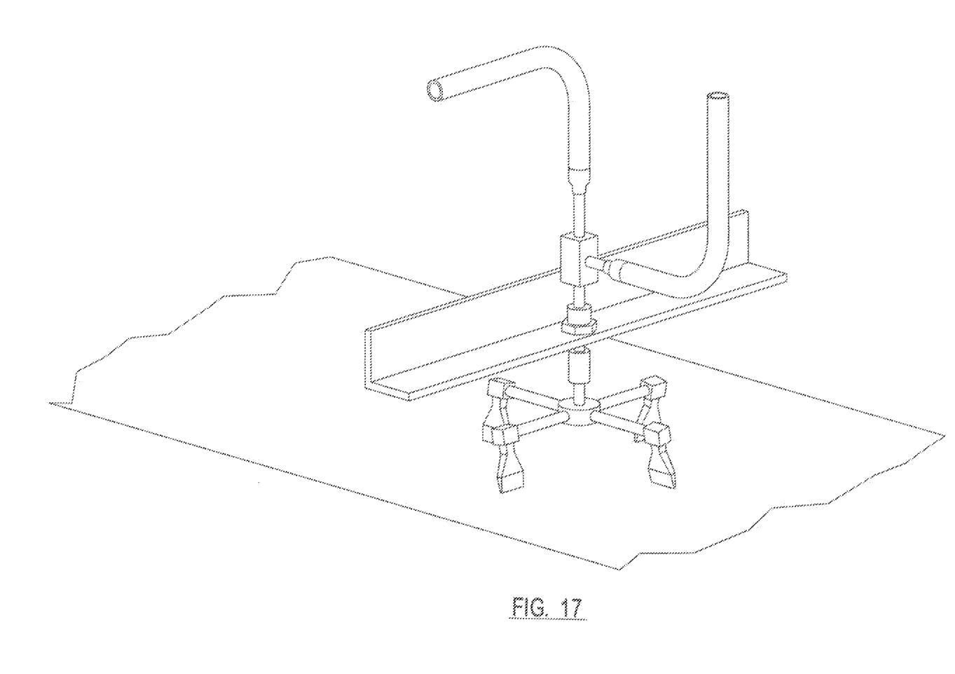

In some embodiments, the peeler may include means for generating rotational movement. For example, and without limitation, a motor may be engaged with swivel assembly 1211/1212 for causing peeler 1255 to rotate. In other examples, swivel assembly 1211/1212 may include a turbine for converting kinetic energy from the forced air jet applied through intake port 1207 to mechanical rotational energy. In some embodiments, rotational movement of the peeler may be caused by providing a slight uniform angular offset to each of the plurality of nozzles. As illustrated in the examples of FIG. 16, and without limitation, each of nozzles 1202a, 1202b may be provided with a slight angular offset 1227 with respect to a central axis running through intake port 1207, swivel assembly 1211/1212, and manifold 1206. In some examples, and without limitation, angular offset 1227 can be between about 5 and about 10 degrees. It is to be appreciated that, for a given volumetric flow rate of forced air and/or fluid through the nozzles, the rotational speed of peeler 1255 is maximized when the peelers are configured with an angular offset of 90 degrees. It is also to be appreciated that the impact force (and thus peeling efficiency) on the produce by the air and/or fluid is greatest when the nozzle is directed tangentially towards the produce (for example, and without limitation, with no angular offset). Thus, in preferred implementations, the angular offset of the nozzles relative to the central rotational axis may be between about 5 and about 40 degrees. However, other angular offsets are contemplated in accordance with some embodiments of the present invention.

In some examples, and without limitation, peeler 1255 can be configured with arms 1203a and 1203b generally parallel to conveyor 1205 upon which the produce passes. However, some embodiments of the present invention contemplate arms which are not parallel to the conveyor. In some examples, and without limitation, the produce may move along conveyor 1205 and underneath a portion of the rotating peeler 1255, where it is subject to air jet expelled from the exhaust vents of nozzles 1202a and 1202b along projection lines 1222a and 1222b, respectively. In some examples, as nozzle 1255 rotates, and as conveyor 1205 transports the produce, the produce may be repeatedly subject to air expelled from nozzle 1202a and air expelled from nozzle 1202b (as intersected by projection lines 1222a and 1222b).

It is to be appreciated that the efficiency at which peeler 1255 can remove the peel from the produce is related to, among other things, the rotational speed of peeler 1255, the transport speed of conveyor 1205, the height from the exhaust vents of nozzles 1202a and 1202b to conveyor 1205 and to a surface of the peel of the produce, the velocity and volumetric flow rate of the air as it exits the exhaust vents of nozzles 1202a and 1202b, and the operational radius of peeler 1255. In some examples, and without limitation, the volumetric flow rate of the air as it leaves exhaust vents of the nozzles is between about 5 and about 50 cubic feet per minute (CFM). However, it is to be appreciated that the volumetric flow rate can be greater 50 CFM or less than 5 CFM depending on, among other things, the number and configuration of peelers and other process parameters, as discussed more fully below. Moreover, the volumetric flow rate can be adjusted for differences in the type of the produce, the quality of the produce, and other similar factors. In some examples, and without limitation, the rotational speed of peeler 1255 can be between about 30 and about 3000 revolutions per minute (RPM). However, it is to be appreciated that depending on various processing parameters, including but not limited to the conveyor speed and the length of the peeler arms, the rotational speed can be greater than 3000 RPM or less than 30 RPM. In some examples, and without limitation, the force exerted by the air and/or fluid on the produce is between about 2 and about 60 Newtons. However, it is to be appreciated that depending on various processing parameters and produce quality factors, the force exerted can be greater than 60 Newtons or less than 2 Newtons. Other process variables are contemplated in accordance with some embodiments of the present invention.

In some examples, and without limitation, the peeler can be configured with a distance of about 2.25 inches between a distal end of the exhaust vent of nozzle 1202a and the produce. However, it is to be appreciated that the peeling radius (for example, and without limitation, the effective spray pattern of air jet projections 1222a and 1222b as it rotates and intersects the produce) is a function of the nozzle geometry and the distance between the exhaust vent of the nozzle and the conveyor. Thus in some embodiments, the peeler may be configurable in multiple height positions for providing adjustable peeling radii. In some examples, and without limitation, the peeling radius of peeler 1255 can be between about 2 and about 10 times less than the diameter of the produce. However, it is to be appreciated that other distances are contemplated in accordance with some embodiments of the present invention.

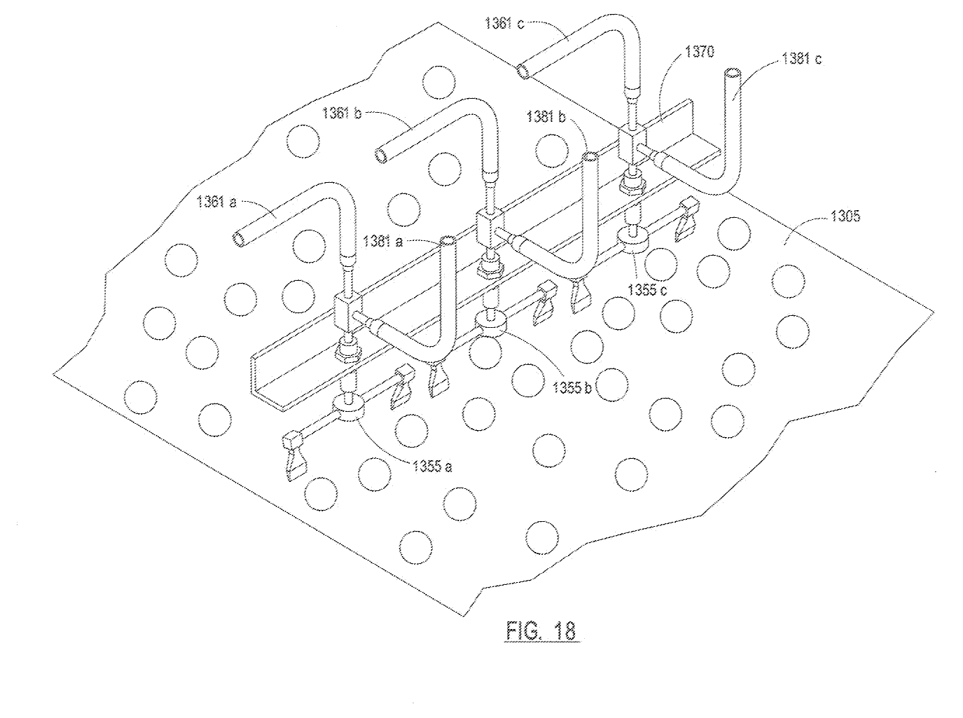

In some embodiments, systems can include a plurality of peelers configured in parallel and/or series. In some examples, and referring to the exemplary illustration of FIG. 18, a plurality of peelers 1355a-1355c may be mounted on frame 1370 disposed above conveyor 1305. It is to be appreciated that, in some embodiments, the peelers may be slightly offset to avoid collision between the nozzles as they rotate with the individual peelers. In some embodiments, timing gears may be associated with the peelers to prevent collision between adjacent peelers. In some embodiments, each peeler may be connected to one or more air supplies through supply lines 1361a-1361c and one or more fluid supplies through supply lines 1381a-1381c. In some examples, and without limitation, each air supply line 1361a-1361c may be engaged with an air manifold (not shown) connected to the air supply. Similarly, each fluid supply line 1381a-1381c may be engaged with a fluid manifold (not shown) connected to the air supply.

It is to be appreciated that as the peelers rotate, the projections of air from the nozzles may form a circular pattern, each circular pattern having a center along a central axis of the respective peeler's swivel assembly. Depending on the placement of a produce along the conveyor, it may tangentially travel through such circular pattern or may travel perpendicularly through both a leading and trailing edge of the circular pattern. Moreover, depending on the placement of a plurality of peelers and the length of the peelers' arms, a produce may tangentially travel at least partially through circular patterns of two adjacent peelers. For example, the produce may travel at a location on the conveyor which is directly between two adjacent peelers.

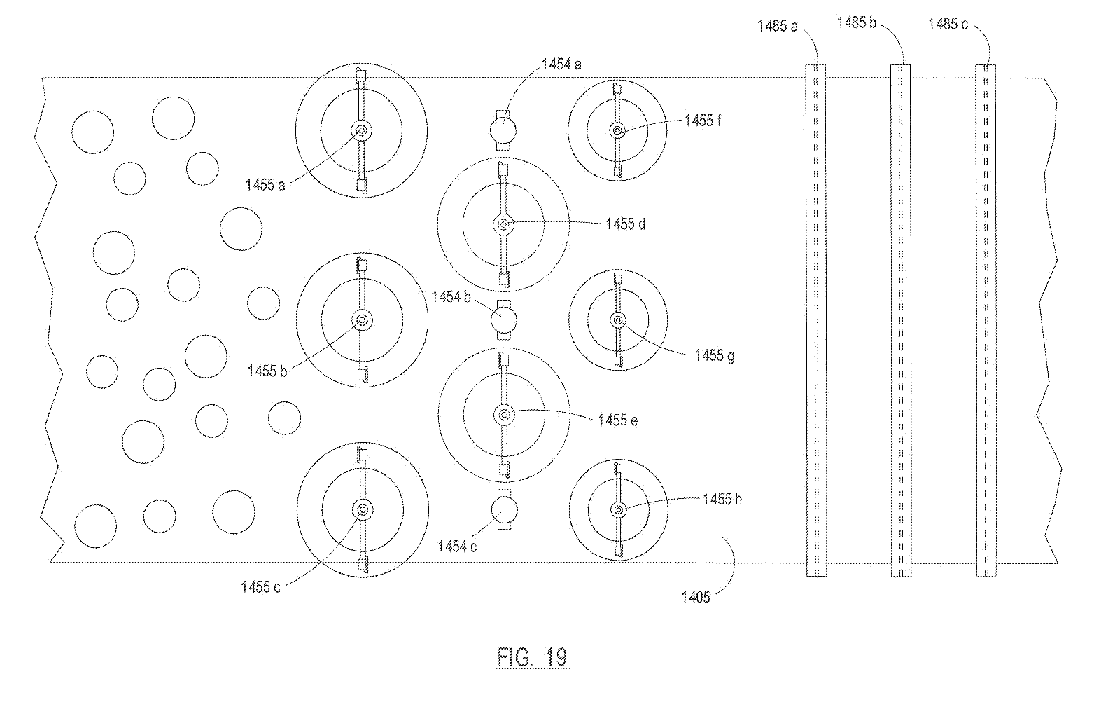

Referring now to the example of FIG. 19, and without limitation, a system for removing the peel from produce moving along conveyor 1405 (as shown operating from left to right) can include a plurality of rotating peelers 1455a-1455h, a plurality of fluid applicators 1454a-1454c, and final rinsing means 1485a-1485c. As illustrated, each of the rotating peelers 1455a-1455h may form air jet patterns (or projections) in the form of circles. In some embodiments, systems can include a plurality of peelers (for example, and without limitation, peelers 1455a-1455c) configured in parallel along the width of conveyor 1405. In some embodiments, systems can include a plurality of peelers (for example, and without limitation, peelers 1455a and 14550 configured in series for subjecting the produce to numerous peeling stages.

In some embodiments, the peelers may be offset or staggered from one another. For example, and without limitation, peelers 1455d-1455e may be offset from peelers 1455a-1455c. It can be appreciated that, staggering helps ensure that in the event a produce travels on conveyor 1405 directly between peelers 1455a and 1455b, the peel of such produce may be separated from the flesh by peeler 1455d. In some embodiments, one or more plows (not shown) can be provided to position the produce on the conveyor relative to the position of the peelers. In some embodiments, the nozzles of the peelers can be configured with a slightly outward angle such that the air projections thereof overlap or otherwise completely cover the width of the conveyor. It is to be appreciated that other ways of ensuring that a produce is subjected to a forced jet of air by at least one peeler regardless of its position on the conveyor are contemplated in accordance with some embodiments of the present invention.

In some examples, and without limitation, peelers 1455a and 1455d may be positioned such that some produce moving along conveyor 1405 may first be peeled at a tangential edge of the air pattern formed by peeler 1455a and then at a tangential edge of the air pattern formed by peeler 1455d. In some examples, and without limitation, peelers 1455a-1455c and peelers 1455f-1455h can be configured such that the produce may be peeled both at a forward and reverse edge of the air pattern formed by peeler 1455a and a forward and reverse edge of the air pattern formed by peeler 1455f. It is to be appreciated that, in some embodiments, regardless of the position of the produce on conveyor 1405, the total volume and velocity of the air and optional fluid incident thereon should remain the same. Thus, in some embodiments, the peelers may each have different sizes, air flow characteristics, nozzle configurations, rotational speed, peeling radii, and the like. For example, and without limitation, the peeling radius of peelers 1455f-1455h may be smaller than the peeling radius of peelers 1455a-1455c and may be configured to provide a lesser volume and lower velocity of air. It is to be appreciated that, although reference is made to the exemplary topology of FIG. 19, systems having other topologies and configurations are contemplated in accordance with some embodiments of the present invention.

As illustrated, and without limitation, a peeling system may also include fluid applicators 1454a-1454c for applying fluid to the produce. In some examples, and without limitation, this fluid may generally correspond to fluid 754 as illustrated in the example of FIG. 9. For example, and without limitation, fluid applicators 1454a-1454c may be located between one or more peelers 1455a-1455h for preventing the peel of the produce from drying out (thus retarding the peeling process). In some examples, although not shown, fluid applicators 1454a-1454c may be located in the center of one or more peelers 1455a-1455h (for example, and without limitation, engaged with bottom ends of manifolds of the peelers). It is to be appreciated that other configurations of fluid applicators are contemplated in accordance with some embodiments of the present invention. As discussed more fully below, in some embodiments, a peeling system may also include final rinse stages 1485a-1485c for applying a rinsing fluid to the produce. In some examples, and without limitation, this rinsing fluid may generally correspond to fluid 765 as illustrated in the example of FIG. 9.

It is to be appreciated that in some embodiments, different peelers may have different configurations and parameters. For example, and without limitation, peelers 1455a-1455c may each be configured to rotate at 3000 RPM, supply air from a blower at a rate of 30 CFM and at a humidity level of 75%, while peelers 1455d-1455h may each be configured to rotate at 1500 RPM, supply a mixture of compressed air and carbon dioxide at a rate of 10 CFM, and at a humidity rate of 90%. It is to be appreciated that the various process parameters may be configurable depending on the type and quality of the produce. For example, and without limitation, late season produce (typically having firmer outer surfaces) may be peeled using relatively higher humidity levels, lower rotating speeds, and lower conveyor belt speeds.

Exemplary Contoured Peelers

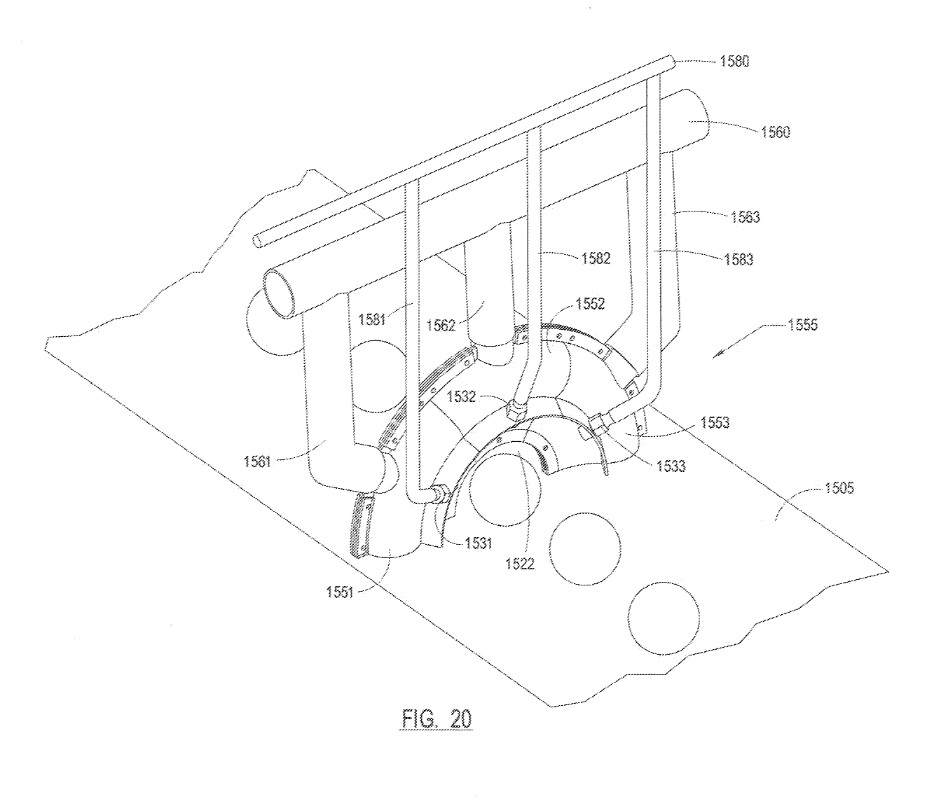

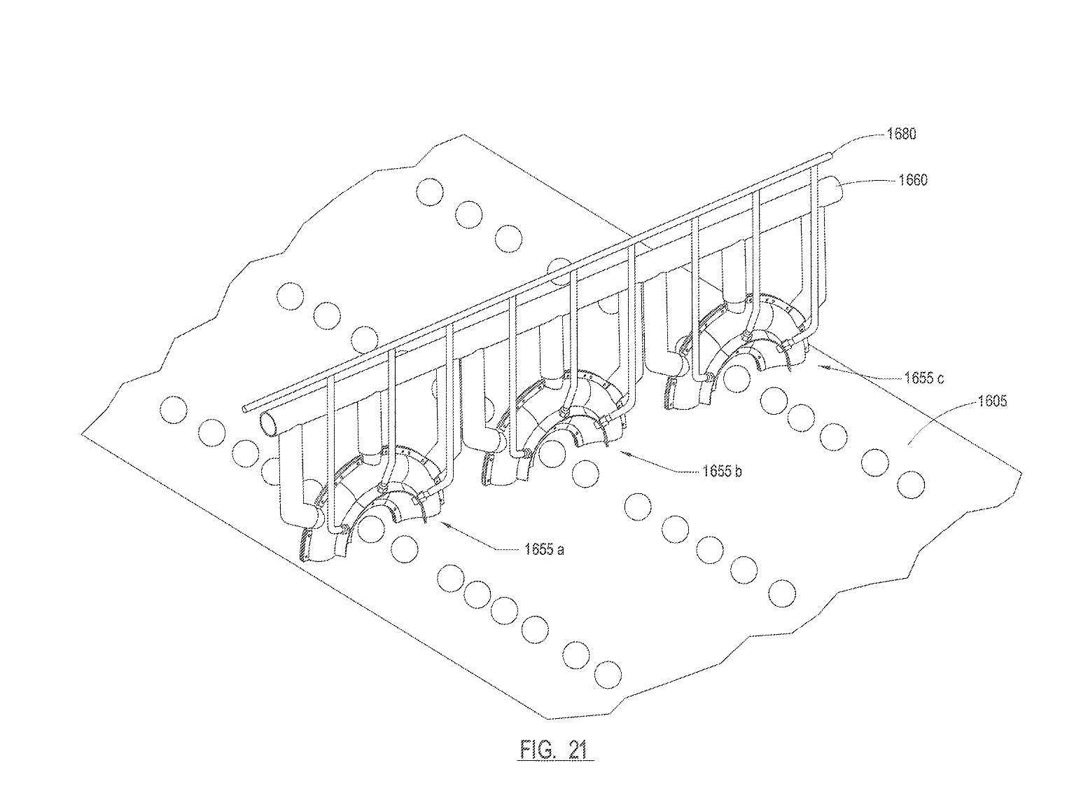

In some embodiments, the exhaust vent of the peeler may have a shape substantially similar to that of the produce. Referring now to the exemplary illustrations of FIG. 20, and without limitation, peeler 1555 may comprise one or more nozzles 1551-1553 defining an opening through which produce along a conveyor 1505 may pass. In some examples, and without limitation, systems can include one or more plows (not shown) for orienting the produce to pass through the peeler opening. In some examples, the plows can be directly engaged with a front end of the peeler itself.

In some examples, and without limitation, each nozzle may have an opening on one or more sides for coupling to other nozzles. For example, nozzles 1551-1553 may be interconnected to form a contiguous unit (such as peeler 1555). Air may flow freely between the interconnected nozzles, or in some examples, restricting means may be provided to modulate air flow. Although the exemplary peeler of FIG. 20 comprises three nozzles, it is to be appreciated that peelers may comprise any number of nozzles in accordance with some embodiments of the present invention. Additionally, in some embodiments, the peeler can comprise a single nozzle.

It is also to be appreciated that the exhaust of the peeler may have a shape substantially similar to that of the produce which is to be peeled. For example, and without limitation, exhaust 1522 of peeler 1555 (comprising nozzles 1551-1553) may be configured with a half circle shape corresponding to a roughly half circle shape of the produce. By configuring the peeler with a shape substantially similar to the produce, the force imparted on the produce by the air jet through the nozzles may be substantially the same over the entire exposed surface of the produce as it passes under the peeler. However, it is to be appreciated that other shapes are contemplated in accordance with embodiments of the present invention.

In some embodiments, each nozzle may be configured with an extended portion at which a first end of a hose or supply line may be attached. In some examples, and without limitation, supply lines 1561-1563 may be attached to extended portions of nozzles 1551-1553, respectively. In some examples, and without limitation, second ends of supply lines 1561-1563 may be connected directly to an air manifold 1560 which in turn can be connected to an air supply (for example, and without limitation, corresponding to air supply 756 of FIG. 9) or other means of generating air movement. In other examples, the second ends of the supply lines may be directly connected to the air supply. If provided, manifold 1560 may be configured to uniformly supply air from the blower to each of the nozzles 1551-1553.

In some embodiments, a fluid applicator may be attached to a front portion of the peeler and/or nozzles. In some examples, and without limitation, applicators 1531-1533 may be attached to nozzles 1551-1553, respectively, for applying a mist of water other fluid (for example, and without limitation, corresponding to fluid 754 of FIG. 9) so as to prevent the peel from drying out during the separation process. In other examples, applicators 1531-1533 may be configured to apply steam to the peel of the produce. Similar to the air supply, each of applicators 1531-1533 may be connected with a fluid supply through supply lines 1581-1583, either directly, or indirectly through fluid manifold 1580. It is to be appreciated that less than all of the nozzles may be connected to air and/or fluid supplies. For example, and without limitation, a peeler may have three interconnected nozzles but only one of which may be connected to an air and a fluid supply.

In some embodiments, exhaust 1522 may direct the forced air jet at a direction perpendicular to the movement of conveyor belt 1505. In other examples, exhaust 1522 may direct the forced air at an angle slightly backwards so as to prevent the air from pushing the produce in a direction opposite from that of the movement of conveyor 1305. However, it is to be appreciated that various angles of orientation are contemplated in accordance with embodiments of the present invention.

In some embodiments, the exhaust of each nozzle may be arched or in the form of a semicircle. For example, and without limitation, the exhaust of each of nozzles 1551-1553 may have geometry defined by an arc of about 60 degrees, the center of the arc being co-located with the center of the produce which may pass there under. However, it is to be appreciated that, in some embodiments, the geometry of the peeler exhaust 1522, and the geometry of the exhaust of the individual nozzles, may have a shape defined by the specific size and geometry of the produce that is to be peeled. For example, and without limitation, the geometries of peelers for removing the peel of a peach may have a geometry defined by the size and shape of a peach. In another example, the geometry of a peeler for removing the skin of a pear may have a geometry defined by the size and the shape of a pear. However, other geometries are contemplated in accordance with embodiments of the present invention.

In some embodiments, the peeler may also be configured to inject a fluid into the air jet. In some examples, and without limitation, an applicator (not shown) may be injected into the air stream by an applicator or mister at a location between the peeler and the blower (or air generation means). For example, and without limitation, an applicator can be engaged with manifold 1560. However, it is to be appreciated that other configurations and means for introducing fluid into the air stream are contemplated in accordance with embodiments of the present invention.

Referring now to FIG. 21, in some embodiments, multiple peelers may be used in parallel. For example, and without limitation, three peelers 1655a-1655c can be provided along the width of conveyor 1605. In some examples, and without limitation, the air and/or fluid supply lines of each of the nozzles of the peelers can be connected to a common air manifold 1660 and/or fluid manifold 1680. However, it is to be appreciated that the peelers, or nozzles of the peelers, may be connected directly to the air and fluid supplies. Similarly, a plurality of manifolds can be provided. For example, and without limitation, the outside nozzles of each peeler 1655a-1655c can be connected to a first air manifold for providing a first air flow rate, while the top nozzles of each peeler 1655a-1655c can be connected to a second air manifold providing a second air flow rate. It is further to be appreciated that, similar to the example of FIG. 19, and without limitation, a plurality of series peelers can be provided. The number of peelers in a given system is to be selected with respect to, among other things, the type, size, and quality of the fruit, the throughput and spatial requirements of the system, and the numbers and strength of the air generating means. In one example, a commercial system in accordance with the present invention may be configured to process eight lines of fruit in parallel, each line having ten series peelers.

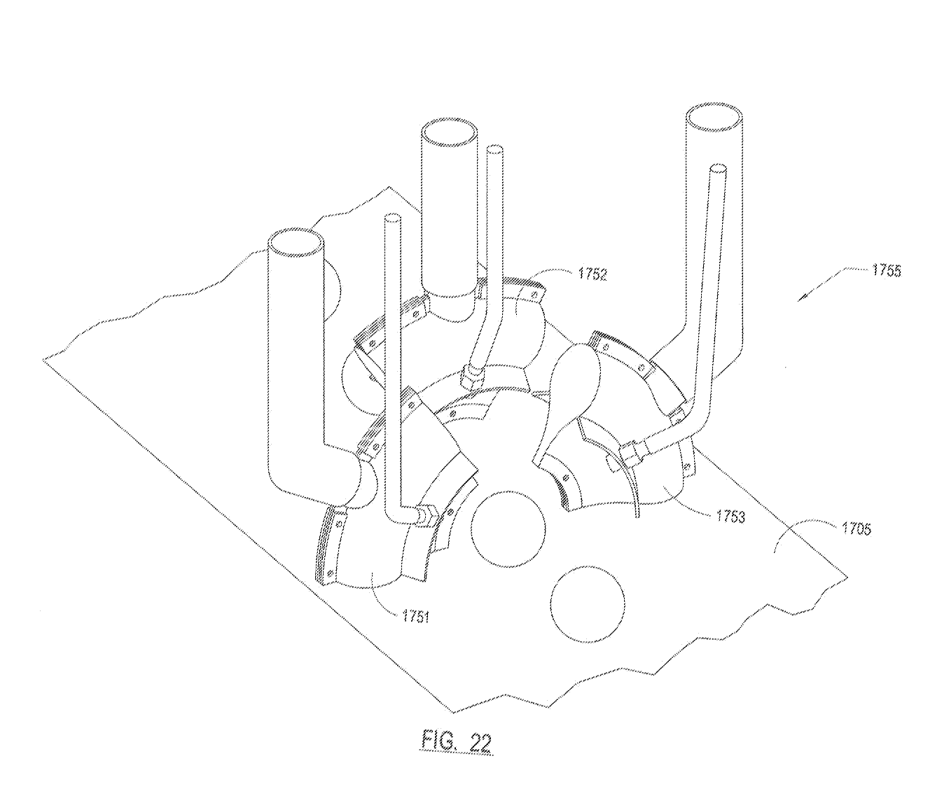

While the use of more than one interconnected nozzles ensures that the air pressure is nearly constantly applied across an entire cross section of the produce, according to some embodiments of the present invention, it may be desired that the air pressure is not constantly applied across the entire section of the produce. As illustrated in the exemplary illustration of FIG. 22, the nozzles may not be connected to each other. In some examples, and without limitation, the air pressure exerted by the top-most nozzle may be greater than the air pressure exerted by the side nozzles. In some embodiments, the orientation of the peeler and/or nozzles may be static or they may be adjustable. For example, and without limitation, one or more of nozzles 1751-1753 of peeler 1755 may be connected to a mechanized means for moving the nozzles while the produce is passing there under. In some embodiments, an optical scanner may be physically attached to the system and in communication with the mechanized means for moving the nozzles to correctly locate the nozzles with respect to the produce. In some other embodiments, the movement and position of the nozzles may be determined by an optical scanner on another device, such as a fruit sorter. By mechanizing the location of the nozzles, each individual piece of produce that passes under the peeler can be subjected to an individually determined air pressure at a determined orientation sufficient to remove the loosened peel of the produce.

Exemplary Flat Peelers

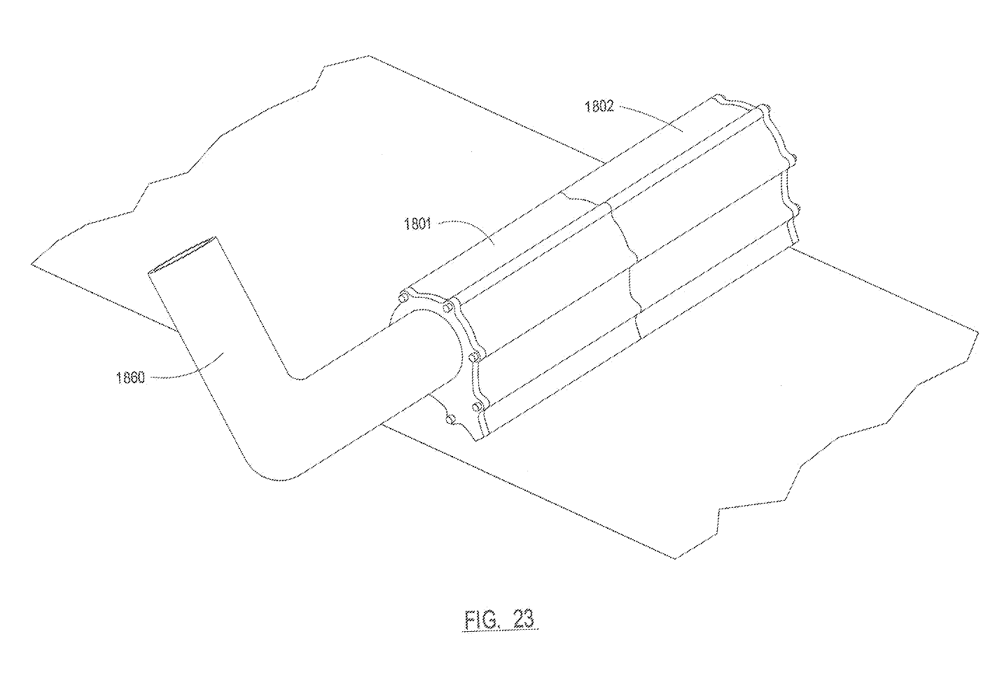

Referring now to the exemplary illustration of FIG. 23, a flat peeler may include one or more nozzles 1801-1802 having a flat-blade exhaust for directing a jet of air towards a portion of produce. In some examples, and without limitation, one or more of the nozzles may be coupled to an air supply line 1860. As above, in some embodiments, the peeler may also include applicators attached to a portion of the nozzles for applying a fluid to a surface of the peel. In some embodiments, another applicator can be configured to inject a fluid or steam into the air through supply line 1860.

The present invention provides methods, apparatuses, and systems which provide an environmentally and economically efficient approach to removing the outer protective surface of agricultural produce by using forced air. It is to be appreciated that the invention may be practiced to remove the peel from peaches, tomatoes, nectarines, pairs, and various other fruits and vegetables. It is to be understood that variations and/or modifications of the present invention may be made without departing from the scope of thereof. For example, and without limitation, systems for separating the peel from the flesh of produce can include both rotating peelers and contoured peelers. In some examples, systems can include a first line of flat peelers for directing a jet of steam to the produce after the lye application stage and a second line of rotating peelers for completely separating the peel from the flesh of the produce. It is also to be understood that the present invention is not to be limited by the specific embodiments, descriptions, or illustrations or combinations of either components or steps disclosed herein. Thus, although various process parameters (including but not limited to time, temperature, pressure, volume, humidity, speed, and the like) were provided in conjunction with one or more examples, it is to be appreciated that these parameters are exemplary and are not meant to limit the scope of the present invention.

What is claimed is:

1. A method for separating an outer peel portion from an inner flesh portion of a piece of agricultural produce, comprising the steps of:
a. at least partially destroying a connection between said peel and said flesh using one of the group consisting of thermal processes, chemical processes, and combinations thereof; and
b. thereafter, exposing a surface of said peel to a jet of air having sufficient kinetic energy to substantially separate said peel from said flesh of said produce.

2. The method of claim 1, wherein said step of at least partially destroying said connection comprises the step of applying a heated caustic fluid to said surface of said peel.

3. The method of claim 2, wherein said step of applying said caustic fluid to said surface of said peel comprises spraying said caustic fluid on said surface of said peel.

4. The method of claim 3, further comprising the step of waiting a first period of time to allow said caustic fluid to react with said connection.

5. The method of claim 4, further comprising the step of exposing said produce to steam during said first period of time.

6. The method of claim 2, wherein said step of applying said caustic fluid to said surface of said peel comprises depositing said piece of produce in a container filled with a heated caustic fluid.

7. The method of claim 1, wherein said step of at least partially destroying said connection comprises the step of exposing said produce to steam.

8. The method of claim 1, wherein said step of exposing said surface of said peel to said jet of air comprises the step of moving said produce along a conveyor underneath said jet of air.

9. The method of claim 1, wherein said jet of air is formed by causing air from one of the group consisting of a blower, a compressor, a tank of compressed gas, and combinations thereof to exit from a nozzle of at least one stationary peeler.

10. The method of claim 1, wherein said jet of air is formed by causing air from one of the group consisting of a blower, a compressor, a tank of compressed gas, and combinations thereof to exit a nozzle of at least one rotating peeler.

11. The method of claim 10, wherein said rotating peeler comprises at least two nozzles rotatable about a first axis, wherein motion of said peeler is imparted by angling exhaust vents of each of said nozzles relative to said first axis.

12. The method of claim 1, further comprising the step of applying a small amount of moisture to said surface of said peel.

13. The method of claim 12, wherein said moisture is applied to said surface of said peel by injecting a fluid into said jet of air.

14. The method of claim 12, wherein said moisture is applied to said surface of said peel by spraying a fluid onto said surface of said peel immediately prior to exposing said surface of said peel to said jet of air.

15. The method of claim 12, wherein said amount of moisture is less than about one gallon per minute per short ton of produce.

16. A method comprising:
a. a conditioning step comprising exposing an agricultural produce to one of the group consisting of steam, water, and combinations thereof, to improve the permeability of a peel of said produce;
b. an application step comprising applying a lye solution to a surface of said peel, said lye comprising one of the group consisting of sodium hydroxide and potassium hydroxide;
c. a reaction step comprising exposing said produce to one of the group consisting of steam, heat, and combinations thereof to cause said lye to loosen said peel from a flesh of said produce;
d. a peel separation step comprising impacting a surface of said peel with a jet of air having sufficient kinetic energy to substantially separate said loosened peel from said flesh; and
e. a rinsing step comprising rinsing said produce with water to remove residual peel and residual lye from said produce.

17. The method of claim 16, further comprising the step of recycling fluid from one of the group consisting of said conditioning step, said application step, said reaction step, said peel separation step, said rinsing step, and combinations thereof.

18. A system comprising:
a. a conveyor for transporting an agricultural produce, said produce comprising an outer peel portion connected to an inner flesh portion;
b. a destroying means, comprising one of the group consisting of caustic fluid, steam, and combinations thereof, for at least partially destroying a connection between said peel and said flesh of said produce; and
c. at least one peeler directing a jet of air towards a surface of said peel of said produce, said air having sufficient kinetic energy to substantially separate said peel from said flesh of said produce.

19. The system of claim 18, wherein said peeler comprises (i) an intake port in fluid communication with an air supply and (ii) at least one nozzle in fluid communication with said intake port.

20. The system of claim 19, wherein said air supply comprises one of the group consisting of a compressor, a blower, a container of compressed gas, and combinations thereof.

21. The system of claim 20, wherein said compressed gas comprises one of the group consisting of hydrogen, nitrogen, carbon dioxide, sulfur dioxide, ozone, and combinations thereof.

22. The system of claim 19, wherein said intake port of said peeler is further in fluid communication with a fluid supply for injecting a fluid into said jet of air.

23. The system of claim 22, wherein said fluid supply comprises one of the group consisting of an atomizer, a steam generator, a humidifier, a water pump, and combinations thereof.

24. The system of claim 23, wherein said fluid comprises one of the group consisting of water, sucrose, an acid, ascorbic acid, citric acid, a neutralizing agent, and combinations thereof.

25. The system of claim 18, further comprising a vertical drum, wherein said conveyor operates helically within said drum, and wherein said at least one peeler is disposed above a portion of said conveyor.

26. The system of claim 18, further comprising a horizontal drum and a rotating screw for transporting said produce within said drum, wherein said at least one peeler is disposed between an axis of said screw and a bottom inside portion of said drum.

27. The system of claim 26, further comprising a plurality of flexible cords extending along said bottom portion of said drum for applying friction to said produce.

28. The system of claim 18, further comprising at least one applicator for applying one of the group consisting of water, sucrose, an acid, ascorbic acid, citric acid, a neutralizing agent, and combinations thereof to said peel.

29. The system of claim 18, further comprising one of the group consisting of an ozone generator, an ionizer, an ultraviolet light source, and combinations thereof.

30. The system of claim 18, wherein said destroying means further comprises at least one applicator for applying said caustic fluid to said surface of said peel.

31. The system of claim 18, wherein said destroying means further comprises a tank of said caustic fluid for temporarily receiving said produce.

32. The system of claim 18, wherein said destroying means further comprises a chamber filled with said steam.

33. The system of claim 18, wherein said destroying means further comprises one of the group consisting of rollers, chains, brushes, cables, cords, knives, and combinations thereof for applying mechanical force to said surface of said peel.

34. The system of claim 18, wherein each of said at least one peeler comprises at least two nozzles, and wherein said nozzles rotate about a first axis.

35. The system of claim 34, wherein said nozzles rotate at between about 30 and 3000 revolutions per minute.

36. The system of claim 18, further comprising a plurality of peelers.

37. The system of claim 36, wherein at least two of said plurality of peelers are configured in series.

38. The system of claim 36, wherein at least two of said plurality of peelers are configured in parallel.

39. The system of claim 36, wherein at least two of said plurality of peelers are staggered from each other.

40. A peeler for separating a peel from a flesh of an agricultural produce, comprising:
a. an intake port in fluid communication with one of the group consisting of a blower, a compressor, a tank of compressed gas, and combinations thereof; and
b. at least one nozzle in fluid communication with said intake port for directing a jet of air towards a surface of said peel of said produce after said peel is loosened from said flesh by one of the group consisting of a caustic fluid applicator, a container of caustic fluid, a steam applicator, a steam chamber, and combinations thereof.

41. The peeler of claim 40, wherein said jet of air has sufficient kinetic energy to substantially separate said peel from said flesh of said produce.

42. The peeler of claim 41, further comprising a swivel assembly between said intake port and said at least one nozzle for enabling rotational movement of said peeler.

43. The peeler of claim 42, configured to rotate about a first axis at between about 30 and about 3000 revolutions per minute.

44. The peeler of claim 42, wherein each said nozzle comprises an exhaust vent at a distal end thereof.

45. The peeler of claim 44, wherein said exhaust vent provides said air at a rate of between about 5 and about 50 cubic feet per minute.

46. The peeler of claim 44, wherein said exhaust vent provides said air at a pressure of between about 30 and about 150 pounds per square inch.

47. The peeler of claim 44, wherein said exhaust vent is between about 2 and about 4 inches from said surface of said peel.

48. The peeler of claim 44, wherein said exhaust vent has a width between about 2 and about 10 times less than a diameter of said produce.

49. The peeler of claim 42, further comprising a manifold between said swivel assembly and said at least one nozzle.

50. The peeler of claim 49, further comprising at least two nozzles and at least two arms, wherein each of said arms is engaged with (i) said manifold on a proximal end and (ii) one of said nozzles on a distal end.

51. The peeler of claim 50, wherein each of said arms have a length of between about 2 and about 5 times a diameter of said produce.

52. The peeler of claim 40, wherein each of said at least one nozzle comprises an exhaust vent having a geometry corresponding to a geometry of said produce.

53. The peeler of claim 52, wherein said exhaust vent has a geometry defined by an arc having an angle of between about 60 and about 180 degrees, wherein the focal point of said arc is about at the same position as the geometrical center of said produce.

54. The peeler of claim 52, further comprising at least two nozzles, wherein each of said nozzles are in fluid communication with each other.

55. The peeler of claim 40, further comprising a fluid applicator in fluid communication with one of the group consisting of a mister, an atomizer, a steam generator, a humidifier, and combinations thereof for applying a fluid onto said surface of said peel.

56. The peeler of claim 40, wherein said intake port is further in fluid communication with one of the group consisting of an atomizer, a steam generator, a humidifier, and combinations thereof for injecting a fluid into said jet of air.

57. A system for removing an outer peel portion of an agricultural product which has been loosened from an inner flesh portion of said produce by one of the group consisting of a caustic means and a steaming means, said system comprising:
a. a plurality of peelers, each peeler directing a jet of air towards a surface of said peel, said air having sufficient kinetic energy to substantially separate said peel from said flesh of said produce;
b. a plurality of fluid applicators, each applicator applying a fluid to said surface of said peel of said produce; and
c. a recycling system collecting discharge from one of the group consisting of said plurality of peelers, said plurality of fluid applicators, and combinations thereof, wherein said recycling system separates said discharge into a solid byproduct and a liquid byproduct.

58. The system of claim 57, wherein at least two peelers are configured in series.

59. The system of claim 58, wherein at least one fluid applicator is located between said at least two series peelers.

60. The system of claim 57, wherein at least two peelers are configured in parallel.

61. The system of claim 57, wherein at least two peelers are staggered from each other.

62. The system of claim 57, wherein each of said peelers comprise a swivel assembly and at least two arms extending from a manifold engaged with said swivel assembly, wherein each of said arms has a nozzle on an end thereof.

63. The system of claim 62, wherein said peelers rotate at between about 30 and about 3000 revolutions per minute.

64. The system of claim 57, wherein said recycler includes a neutralizing agent for neutralizing said solid byproduct.

65. The system of claim 57, wherein at least one of said fluid applicators receive said liquid byproduct from said recycler.

66. The system of claim 57, wherein at least one of said fluid applicator comprises one of the group consisting of a mister, an atomizer, a steam generator, a humidifier, and combinations thereof.

67. The system of claim 57, further comprising at least one of the group consisting of an atomizer, a steam generator, a humidifier, and combinations thereof for injecting a fluid into said jet of air.

68. A system having one of the group consisting of a caustic peeler, a steam peeler, and combinations thereof for loosening a peel from the flesh of a produce, an improvement comprising at least one peeler directing a jet of air towards a surface of said peel, said air having sufficient kinetic energy to substantially separate said peel from said flesh of said produce.

69. The system of claim 68, further comprising one of the group consisting of a mister, an atomizer, a steam generator, a humidifier, and combinations thereof for applying a fluid on said surface of said peel of said produce.

70. A method for removing peels from harvested agricultural crops comprising the steps of:
a. exposing said crops to one of the group consisting of steam, water, and combinations thereof to improve the permeability of said peels;
b. applying a first solution to surfaces of said peels, said first solution comprising lye;
c. exposing said surfaces of said peels to one of the group consisting of steam, heat, and combinations thereof to cause said solution to loosen said peels from inner flesh portions of said crops;
d. directing at least one jet of air toward said surfaces of said peels, wherein said jet of air has sufficient kinetic energy to substantially separate said peels from said flesh portions; and
e. rinsing said crops with water to remove any of said first solution remaining on said crops.

71. The method of claim 70, further comprising the steps of collecting said separated peels and neutralizing said separated peels with a neutralizing agent.

72. The method of claim 70, further comprising the step of collecting the water used to remove said remaining first solution.

73. The method of claim 72, further comprising the steps of adding concentrated lye to said collected water and recycling said collected water and said concentrated lye into said first solution.

74. The method of claim 72, further comprising the steps of recycling the said collected water and using it to remove any of said first solution remaining on additional crop.
